(19) United States
(12) Patent Application Publication
(10) Pub. No.: US 2018/0052264 A1
(43) Pub. Date: Feb. 22, 2018

(54) TRANSPARENT SCREEN

(71) Applicant: FUJIFILM Corporation, Tokyo (JP)

(72) Inventors: Yukito SAITOH, Minami-ashigara-shi (JP); Yujiro YANAI, Minami-ashigara-shi (JP); Akira YAMAMOTO, Minami-ashigara-shi (JP); Nobuhiko ICHIHARA, Minami-ashigara-shi (JP); Daisuke KASHIWAGI, Minami-ashigara-shi (JP); Michio NAGAI, Minami-ashigara-shi (JP)

(73) Assignee: FUJIFILM Corporation, Tokyo (JP)

(21) Appl. No.: 15/796,531

(22) Filed: Oct. 27, 2017

Related U.S. Application Data
(63) Continuation of application No. PCT/JP2016/062958, filed on Apr. 26, 2016.

(30) Foreign Application Priority Data
Apr. 30, 2015 (JP) 2015-092964

(51) Int. Cl. G02B 5/26; G03B 21/60

(52) U.S. Cl. CPC G02B 5/26; G03B 21/60

(57) ABSTRACT

A transparent screen includes a substrate capable of transmitting light; and a plurality of dots formed on a surface of the substrate, each of the dots having wavelength-selective reflectivity and being formed of a liquid crystal material having a cholesteric structure, in which the cholesteric structure gives a striped pattern of bright parts and dark parts in a cross-sectional view of the dot observed by a scanning electron microscope, the dot includes a portion having a height that increases continuously to the maximum height in a direction extending from the edge toward the center of the dot, the angle formed by the normal line to a line that is formed by a first one of the dark parts as counted from the surface of the dot on the opposite side of the substrate and the surface of the dot, in the portion, is in the range of 70° to 90°, and a plurality of dot row units in which two or more dots are adjacently arranged along one direction are formed.

### CROSS-REFERENCE TO RELATED APPLICATIONS

This application is a Continuation of PCT International Application No. PCT/JP2016/062958 filed on Apr. 26, 2016, which claims priority under 35 U.S.C. § 119(a) to Japanese Patent Application No. 2015-092964 filed on Apr. 30, 2015. The above application is hereby expressly incorporated by reference, in its entirety, into the present application.

### BACKGROUND OF THE INVENTION

### 1. Field of the Invention

The present invention relates to a transparent screen.

### 2. Description of the Related Art

In recent years, transparent screens in which light from the front surface side is reflected and light from the back surface side is transmitted, have been proposed as one of display devices.

For example, JP2006-337944A describes a semi-transmissive type reflective screen including a base material layer that is capable of transmitting light and is formed into an approximately flat parallel plate; a plurality of unit shapes capable of transmitting light, which protrudes on the back surface side of the base material layer, which is an opposite side of the video source side, and are one-dimensionally or two-dimensionally arrayed in a row along a screen surface; and a reflective layer that is provided at the apex of the back surface side of the unit shapes and reflects the video light that has been transmitted through the unit shapes, in which the unit shapes are arranged with gaps therebetween, and in the space between the unit shapes are arranged, a background transmission unit is provided in a state of being exposed to the base material layer or a flat surface parallel to the base material layer. This semi-transmissive type reflective screen is a screen with which the background on the back surface side can be observed from the front, while the video light from the front is reflected by means of a reflective surface and is made observable.

### SUMMARY OF THE INVENTION

Generally, reflective type screens can be classified into a diffusion type, a recursion type, and a mirror reflection type, depending on the reflection characteristics.

A diffusion type screen uniformly diffuses and reflects light that has hit the surface into all directions without deflection. Therefore, the overall brightness is not so high; however, the viewing angle can be made wider.

A recursion type screen reflects light in a direction in which the light has been projected. Therefore, the brightness obtainable when viewed from the vicinity of a light source can be made high.

A mirror reflection type screen reflects light such that the incident angle of light is equal to the reflected angle, in the same manner as in the case of light being reflected by a mirror. Therefore, the brightness obtainable when viewed at the position of a reflected angle with respect to the incident angle of light from a light source, can be made high.

Such a recursion type or mirror reflection type screen can have the brightness increased in a particular direction; however, since the brightness in other directions is lowered, the screen has a feature that the viewing angle is narrowed.

Here, in regard to a transparent screen that reflects light from the front surface side and transmits light from the back surface side, it is requested to enhance the performance of transmitting light from the back surface, in addition to an enhancement in the reflection performance such as an increase in the brightness of projected light or an increase in the viewing angle.

However, in a case where diffusibility is increased in a transparent screen in order to widen the viewing angle, there is a problem that the haze value increases, while transparency is lowered. On the contrary, in a case where transparency is increased, since the reflection behaves more like mirror reflection, there is a problem that the viewing angle is narrowed.

In view of such circumstances, it is an object of the invention to provide a transparent screen having excellent transparency and an excellent viewing angle.

The inventors of the invention conducted a thorough investigation on the problems of the prior art technologies, and as a result, the inventors found that the problems can be solved by providing a transparent screen including a substrate capable of transmitting light; and a plurality of dots formed on a surface of the substrate, each of the dots having wavelength-selective reflectivity and being formed of a liquid crystal material having a cholesteric structure, in which the cholesteric structure gives a striped pattern of bright parts and dark parts in a cross-sectional view of the dot observed by a scanning electron microscope, the dot includes a portion having a height that increases continuously to the maximum height in a direction extending from the edge toward the center of the dot, in the portion, the angle formed by the normal line to a line that is formed by a first one of the dark parts as counted from the surface of the dot on the opposite side of the substrate and the surface of the dot is in the range of 70° to 90°, and a plurality of dot row units in which two or more dots are adjacently arranged along one direction are formed.

That is, the inventors found that the above-described object can be achieved by the following configurations.

(1) A transparent screen comprising: a substrate capable of transmitting light; and a plurality of dots formed on a surface of the substrate, each of the dots having wavelength-selective reflectivity and being formed of a liquid crystal material having a cholesteric structure, wherein the cholesteric structure gives a striped pattern of bright parts and dark parts in a cross-sectional view of the dot observed by a scanning electron microscope, the dot includes a portion having a height that increases continuously to the maximum height in a direction extending from the edge toward the center of the dot, in the portion, the angle formed by the normal line to a line that is formed by a first one of the dark parts as counted from the surface of the dot on the opposite side of the substrate and the surface of the dot is in the range of 70° to 90°, and a plurality of dot row units in which two or more dots are adjacently arranged along one direction are formed.

(2) The transparent screen according to (1), wherein in the plurality of dot row units, arrangement directions of the dots are parallel to each other.

(3) The transparent screen according to (1) or (2), wherein a distance between the dots adjacent to each other in a direction orthogonal to the arrangement direction of the dot in the dot row unit is longer than a distance between the dots in the dot row unit.

(4) The transparent screen according to any one of (1) to (3), wherein in the dot row unit, diameters of the dots are identical.

(5) The transparent screen according to any one of (1) to (4), wherein in the dot row unit, the dots are formed so that the diameters of the dots are gradually reduced in one direction of the arrangement directions of the dots.

(6) The transparent screen according to any one of (1) to (5), wherein the plurality of dots include two or more kinds of dots that reflect light in wavelength regions different from each other.

(7) The transparent screen according to (6), wherein in the dot row unit, the reflection wavelengths of the dots are identical.

(8) The transparent screen according to any one of (1) to (7), which includes dots each having, in a single dot, two or more regions that reflect light in wavelength regions different from each other.

(9) The transparent screen according to any one of (1) to (8), wherein the liquid crystal material is a material obtainable by curing a liquid crystal composition including a liquid crystal compound, a chiral agent, and a surfactant.

According to the invention, a transparent screen having excellent transparency and an excellent viewing angle can be provided.

### BRIEF DESCRIPTION OF THE DRAWINGS

FIG. 1A is a front view conceptually illustrating an example of a transparent screen of the invention.

FIG. 1B is a cross-sectional view of FIG. 1A cut along the line B-B.

FIG. 1C is a cross-sectional view of FIG. 1A cut along the line C-C.

FIG. 2 is a schematic front view of another example of the transparent screen of the invention.

FIG. 3A is a schematic front view of another example of the transparent screen of invention.

FIG. 3B is a cross-sectional view of FIG. 3A cut along the line B-B.

FIG. 4 is a schematic front view of another example of the transparent screen of the invention.

FIG. 5 is a schematic front view of another example of the transparent screen of the invention.

FIG. 6A is a schematic cross-sectional view of an example of a dot constituting the transparent screen of the invention.

FIG. 6B is a schematic cross-sectional view of another example of a dot constituting the transparent screen of the invention.

FIG. 6C is a schematic cross-sectional view of another example of a dot constituting the transparent screen of the invention.

FIG. 7 is a schematic cross-sectional view of another example of the transparent screen of the invention.

FIG. 8 is a view illustrating an image obtained by observing, by a scanning electron microscope (SEM), a cross-section of the dots of a transparent screen manufactured in an Example.

FIG. 9A is a view for explaining a method for measuring the front surface brightness and the right and left brightness.

FIG. 9B is a view for explaining another method for measuring the front surface brightness and the right and left brightness.

FIG. 10 is a view conceptually illustrating an example of a cross-section of a dot.

FIG. 11 is a schematic cross-sectional view for explaining the action of dots.

### DESCRIPTION OF THE PREFERRED EMBODIMENTS

The transparent screen of the invention will be explained in detail below. A numerical value range represented by using “to” in the present specification means a range including the numerical values described before and after “to” as the lower limit and the upper limit, respectively.

According to the present specification, for example, an angle such as “45°”, “parallel”, “perpendicular” or “orthogonal” means that unless particularly stated otherwise, the difference between the angle and the exact angle is in the range of smaller than 5 degrees. The difference between the angle and the exact angle is preferably smaller than 4 degrees, and more preferably smaller than 3 degrees.

According to the present specification, the term “(meth)acrylate” is used to mean “any one or both of acrylate and methacrylate”.

According to the present specification, the term “same” is meant to include an error range that is generally tolerable in the technical field. According to the present specification, in a case where it is said “entirety”, “all” or “entire surface”, the terms are meant to include error ranges that are generally tolerable in the technical field, in addition to the case of being 100%, and to include the cases of, for example, 99% or more, 95% or more, or 90% or more.

Visible light is light having wavelengths that can be seen by human eyes among the electromagnetic waves and indicates light in the wavelength region of 380 nm to 780 nm. Non-visible light is light in the wavelength region of shorter than 380 nm or in the wavelength region of longer than 780 nm.

Without being limited to this, light in the wavelength region of 420 nm to 495 nm in the visible light is blue light, light in the wavelength region of 495 nm to 570 nm is green light, and light in the wavelength region of 620 nm to 750 nm is red light.

In the infrared light, near-infrared light is an electromagnetic wave in the wavelength region of 780 nm to 2,500 nm. Ultraviolet light is light in the wavelength region of 10 nm to 380 nm.

Recursive reflection according to the present specification means reflection by which incident light is reflected in the direction of incidence.

According to the present specification, the term “haze” means a value measured using a haze meter, NDH-2000, manufactured by Nippon Denshoku Industries Co., Ltd.

Theoretically, the haze means a value represented by the following expression.

(Diffuse transmittance of natural light at 380 to 780 nm)/(diffuse transmittance of natural light at 380 to 780 nm+direct transmittance of natural light)×100%

The diffuse transmittance is a value that can be calculated by subtracting the direct transmittance from the omnidirectional transmittance obtainable by using a spectrophotometer and an integrating sphere unit. The direct transmittance in the case based on the value measured using an integrating sphere unit is transmittance at 0°.

The transparent screen of the invention has a substrate capable of transmitting light; and a plurality of dots formed on the surface of the substrate, the dots having wavelength-selective reflectivity and being formed of a liquid crystal material having a cholesteric structure, in which the cholesteric structure gives a striped pattern of bright parts and dark parts in a cross-sectional view of a dot observed by a scanning electron microscope, each of the dots includes a portion having a height that increases continuously to the maximum height in a direction extending, from the edge toward the center of the dot, the angle formed by the normal line to a line that is formed by a first one of the dark parts as counted from the surface of the dot on the opposite side of the substrate and the surface of the dot, in the portion, is in the range of 70° to 90°, and a plurality of dot row units in which two or more dots are adjacently arranged along one direction are formed.

<Transparent Screen>

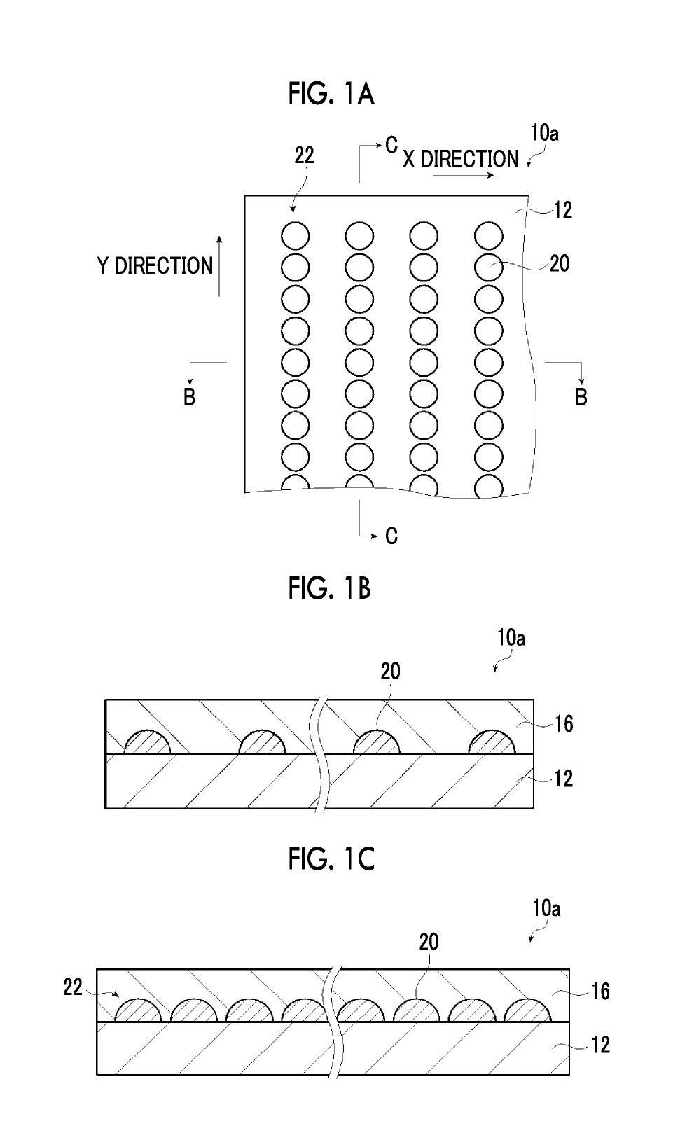

An example of suitable embodiments of the transparent screen of the invention will be explained below with reference to the drawings. FIG. 1A illustrates a front view of an example of the transparent screen of the invention, FIG. 1B illustrates a cross-sectional view of FIG. 1A cut along the line B-B, and FIG. 1C illustrates a cross-sectional view of FIG. 1A cut along the line C-C.

The diagrams presented for the invention are schematic diagrams, and the relations of the thicknesses of various layers, the positional relations, and the like do not necessarily coincide with the actual relations. The same also applies to the following diagrams.

As illustrated in FIG. 1A to FIG. 1C, a transparent screen 10a has a substrate 12 capable of transmitting light; a plurality of dots 20 formed on one principal surface of the substrate 12; and an overcoat layer 16 formed on the surface on the side where the dots 20 are formed, so as to embed the dots 20.

In FIG. 1A, the overcoat layer 16 is not shown in the diagram.

Video light enters through the surface on the side where the dots 20 are formed. That is, the surface on the side where the dots 20 are formed is a front surface, and the surface on the opposite side is a back surface.

Since the dots 20 are formed of a liquid crystal material having a cholesteric structure having wavelength-selective reflectivity, the video light that enters through the surface of the transparent screen 10a on the side where the plurality of dots 20 are formed is reflected at the surface of a dot 20. Here, since a dot 20 is formed into an approximately hemispheric shape, the incident angle of the incident video light changes correspondingly to the various positions on the surface of the dot 20. Accordingly, the video light is reflected in various directions, and an effect that the viewing angle is widened can be manifested.

Based on the wavelength region of the incident video light, the dots 20 have wavelength-selective reflectivity of selectively reflecting light in this wavelength region.

The cholesteric structure of the liquid crystal material that constitutes the dots 20 gives a striped pattern of bright parts and dark parts in a cross-sectional view of a dot observed by a scanning electron microscope and includes a portion having a height that increases continuously to the maximum height in a direction extending from the edge toward the center of the dot, and in the portion, the angle formed by the normal line to a line that is formed by a first one of the dark parts as counted from the surface of the dot on the opposite side of the substrate and the surface of the dot is in the range of 70° to 90°.

More detailed explanation in this regard will be given later.

Here, as illustrated in FIG. 1A, the transparent screen 10a of the invention is configured to include a plurality of dot row units 22 formed by adjacently arranging two or more dots 20 along one direction.

Specifically, in the transparent screen 10a, the dot row unit 22 is formed by arranging the plurality of dots 20 in a row in the vertical direction as shown in the diagram, the plurality of dot row units 22 are arranged in a direction (a horizontal direction in the diagram) orthogonal to the arrangement direction of the dots 20 in the dot row unit 22. Therefore, in the plurality of dot row units 22, the arrangement directions of the dots 20 are parallel to each other.

A distance between the dots 20 in the dot row unit 22 is shorter than a distance between the dot row units 22. That is, the distance between the dots 20 adjacent to each other in a direction orthogonal to the arrangement direction of the dot 20 in the dot row unit 22 is longer than a distance between the dots 20 in the dot row unit 22.

In the following description, in the dot row unit, the arrangement direction of the dot is referred to as a Y direction and the direction orthogonal to the Y direction is referred to as an X direction.

As described above, for a transparent screen which reflects light from the front surface side and transmits light from the back surface side, it is requested to enhance the performance of transmitting light from the back surface, in addition to an enhancement in the reflection performance such as an increase in the brightness of projected light or an increase in diffusibility.

However, in regard to the transparent screen in the related art, in a case where diffusibility is increased in order to widen the viewing angle, there is a problem that the haze value increases, and transparency is lowered. In contrast, in a case where transparency is increased, since the reflection behaves more like mirror reflection, there is a problem that the viewing angle is narrowed.

In this regard, according to the invention, since light in a particular wavelength region can be reflected, and light in other wavelength regions can be transmitted by using a liquid crystal material having a cholesteric structure, a transparent screen which is capable of reflecting video light that is emitted from a video device such as a projector and enters the front surface, and transmitting light from the back surface, so that the video light and the background on the back surface side can be viewed in a superimposed manner, can be provided.

Here, in a case where such a liquid crystal material having a cholesteric structure is formed into a flat layer, the minor reflectivity is enhanced, and diffusibility for the incident video light is decreased. Therefore, the viewing angle is narrowed.

In this regard, according to the invention, a liquid crystal material having a cholesteric structure is formed into a plurality of dot-like bodies, this cholesteric structure of the dots give a striped pattern of bright parts and dark parts in a cross-sectional view of a dot observed by a scanning electron microscope and includes a portion having a height that increases continuously to the maximum height in a direction extending from the edge toward the center of the dot, and at least at three dots in the portion, the angle formed by the normal line to a line that is formed by the first dark part as counted from the surface of the dot on the opposite side of the substrate and the surface of the dot is in the range of 70° to 90°. Therefore, light can be reflected in any direction in addition to mirror reflection, and the viewing angle can be widened without lowering transparency.

Moreover, in the invention, it is preferable that the plurality of dot row units in which two or more dots are adjacently arranged along the Y direction are formed, and the distance between the dots in the dot row unit is shorter than the distance between the dots adjacent to each other in the X direction. According to the configuration, in the X direction, the viewing angle can be widened due to the effect of the shape and the structure of the dot, and in the Y direction, the front surface brightness can be increased.

Specifically, in the Y direction, in a case where the video light is incident to a dot, light reflected by the dot is reflected so as to diffuse in various directions due to the effect of the shape and the structure of the dot. Here, since dots are adjacently arranged in the Y direction, light reflected so as to diffuse in directions other than a front surface direction is incident to the adjacent dot and reflected in the front surface direction, or is repeatedly reflected in the above manner between the adjacent dots and is reflected in the front surface direction. Thereby, the front surface brightness in the Y direction can be increased.

That is, in the transparent screen of the invention, the plurality of dot row units in which two or more dots are adjacently arranged along the Y direction are formed. Therefore, the reflection characteristics in the X direction and in the Y direction are different from each other, in the X direction, the viewing angle can be widened, and in the Y direction, the front surface brightness can be increased.

Here, generally, a direction required a wider viewing angle in a case where the video light is projected on the transparent screen to display a video image is the horizontal direction rather than the perpendicular direction. For example, in a case where the video image displayed on the transparent screen is observed by numerous viewers or is observed by a viewer who changes a position during display of the video image, the viewing angle wide in the horizontal direction is required.

Therefore, by installing the transparent screen of the invention so as to match the X direction with the horizontal direction and match the Y direction with the perpendicular direction, the viewing angle in the horizontal direction is widened and the front surface brightness can be increased while widening the actual viewing angle.

In the invention, the expression that the dots are adjacent to each other in the dot row unit means that a pitch D satisfies (R1+R2)≦D<2(R1+R2), where radii of two dots continuously arranged are respectively set to R1 and R2 and the pitch (distance between centers) between dots is set to D.

Basically, the adjacent dots so not contact with each other, but edge sides thereof may contact with each other.

Here, in regard to the transparent screen 10a illustrated in FIG. 1B, a preferred aspect thereof has an overcoat layer 16 that is formed so as to cover the dots 20. However, the invention is not intended to be limited to this, and a configuration in which the dots 20 are exposed without having the overcoat layer is also acceptable.

According to the invention, in a case where the transparent screen has an overcoat layer 16 as in the case of the transparent screen 10a illustrated in FIG. 1B, it is preferable from the viewpoint that transparency can be improved by eliminating surface unevenness caused by the plurality of dots 20.

Furthermore, in the case of forming the overcoat layer 16, from the viewpoint of further enhancing transparency by suppressing reflection at the interface between the overcoat layer 16 and the dots 20, it is preferable as the difference between the refractive index of the overcoat layer 16 and the refractive index of the dots 20 is smaller. The difference in the refractive index is preferably 0.10 or less and more preferably 0.04 or less.

In the example illustrated in FIG. 1A, all of the dots 20 arranged in a row in the Y direction form the dot row unit 22, but the invention is not intended to be limited to this, and a configuration in which the dot row unit is formed by adjacently arranging two or more dots in the Y direction is also acceptable.

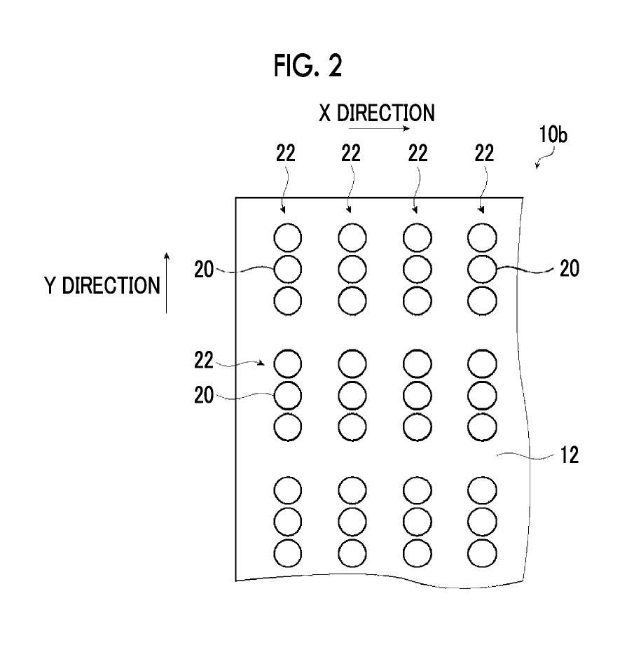

For example, in the transparent screen 10b illustrated in FIG. 2, the dot row unit 22 in which three dots are adjacently arranged in the Y direction is formed. The transparent screen 10b has a plurality of the dot row units 22, and the plurality of the dot row units 22 are arranged in the X direction and the Y direction at a predetermined interval.

A ratio W2/W1 of a width W2 of the dot row unit 22 in the Y direction to a width W1 of the dot row unit 22 in the X direction is preferably 2 or greater and more preferably 3 or greater. Therefore, in the Y direction, it is possible to more suitably guide the reflected light in the front surface direction and to further increase the front surface brightness.

In the example illustrated in FIG. 2, the plurality of the dot row units 22 are arranged in the X direction and the Y direction at a predetermined interval, but there are no particular limitations on the arrangement of the dot row units as long as the arrangement directions of the dots 20 in the dot row unit 22 are parallel to each other.

The distance between dot row units adjacent to each other in the X direction, that is, the distance between dots adjacent to each other in the X direction is preferably 15 μm or greater and more preferably 20 μm to 500 μm.

The distance between dot row units adjacent to each other in the Y direction is preferably 200 μm or less and more preferably 20 μm to 200 μm.

In the example illustrated in FIG. 1A, sizes (diameter and height) of all dots are the same; however, the invention is not intended to be limited to this, and dots having different sizes may be included. In a case of including the dots having different sizes, a configuration in which the sizes of the dots are made the same in the dot row unit and the sizes of the dots for each dot row unit are changed or a configuration in which the dots having different sizes are included in the dot row unit is adopted.

Here, in the dot row unit, the dots are preferably formed so that the diameters of the dots are gradually reduced in one direction of the arrangement directions of the dots.

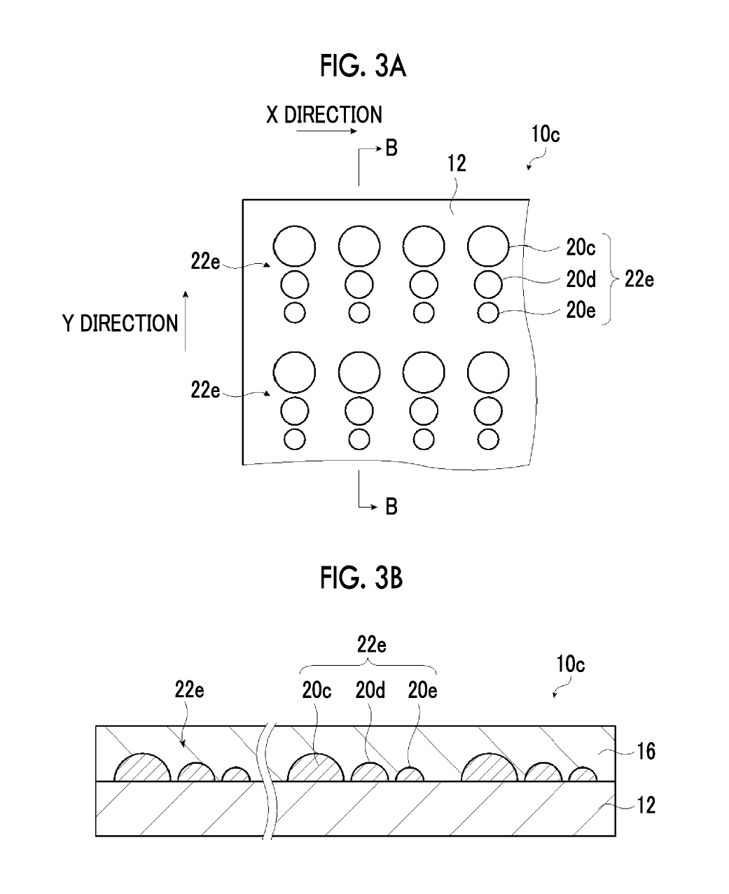

FIG. 3A illustrates a schematic front view of another example of the transparent screen of the invention and FIG. 3B illustrates a cross-sectional view of FIG. 3A cut along the line B-B.

The transparent screen 10c illustrated in FIG. 3A and FIG. 3B includes a plurality of dot row units 22e formed by three dots adjacently arranged.

As illustrated in FIG. 3A, the dot row units 22e includes a dot 20c having the largest diameter, a dot 20d having the intermediate diameter, and a dot 20e having the smallest diameter, and these dots are arranged in this order in the downward direction as shown in the diagram.

For the reason, as illustrated in FIG. 3B, in a case of being viewed from a cross-section of the dots in the arrangement directions, a virtual line connecting apexes of the three dots 20c to 20e is inclined to a principal surface of a substrate 12.

By adopting such a configuration, for example, in a case of using a short focus projector as a video source, that is, in a case where the video light is projected on the transparent screen with a large projection angle from an oblique direction and reflected in the front surface direction of the transparent screen, the reflected light can be more suitably reflected in the front surface direction of the transparent screen.

The plurality of dots 20 thus formed may be such that all of the dots 20 reflect light in the same wavelength region; however, the invention is not intended to be limited to this, and a configuration including two or more kinds of dots that reflect light in wavelength regions different from each other is also acceptable.

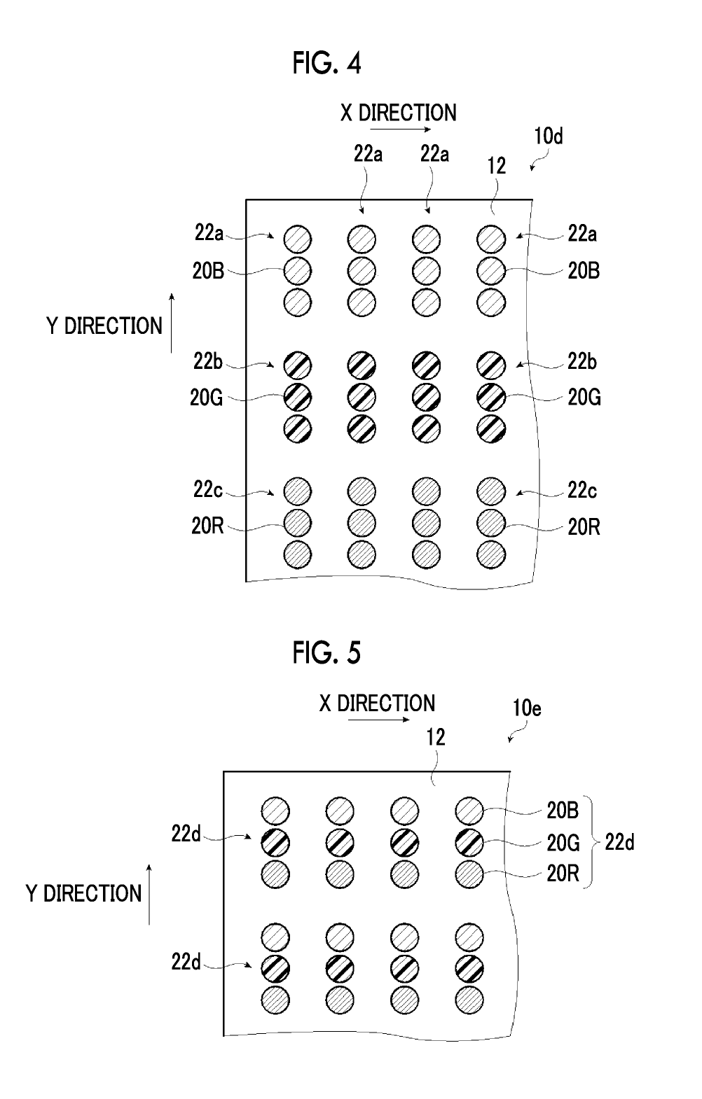

For example, the transparent screen 10d illustrated in FIG. 4 is configured to include a plurality of red dots 20R that reflect red light in the wavelength region of 610 nm to 690 nm, a plurality of green dots 20G that reflect green light in the wavelength region of 515 nm to 585 nm, and a plurality of blue dots 20B that reflect blue light in the wavelength region of 420 nm to 480 nm, and to include a plurality of blue dot row units 22a having the three blue dots 20B adjacently arranged, a plurality of green dot row units 22b having the three green dots 20G adjacently arranged, and a plurality of red dot row units 22c having the three red dots 20R adjacently arranged.

In the example illustrated in the drawing, in the Y direction, the blue dot row unit 22a, the green dot row unit 22b, and the red dot row unit 22c are repeatedly arranged in this order. On the other hand, in the X direction, any of the blue dot row units 22a, the green dot row units 22b, and the red dot row units 22c are arranged in a row.

As such, in a case where dots reflecting red light, dots reflecting green light, and dots reflecting blue light are included, it is preferable from the viewpoint that the red light, green light and blue light of the video light entering through the front surface can be reflected, and a video image that is projected on the transparent screen can be displayed as a color image, and from the viewpoint that the video light emitted from a video device such as a projector can be utilized regardless of whether the light is red light, green light or blue light.

The example illustrated in FIG. 4 is configured to include dots that respectively reflect red light, green light, and blue light; however, the invention is not intended to be limited to this, and the transparent screen may also include dots that reflect light in other wavelength regions.

It is desirable that the dots that respectively reflect red light, green light, and blue light are dots reflecting light in the above-mentioned wavelength regions, and it is also acceptable that the peak wavelength of the reflected waves may not be included in the range of the wavelength regions described above.

The invention is not limited to a configuration including three kinds of dots that reflect red light, green light, and blue light, respectively, and for example, a configuration including two kinds of dots such as dots that reflect red light and dots that reflect blue light may be employed, or a configuration including four or more kinds of dots such as the dots respectively reflect red light, green light, and blue light, as well as dots that reflect light in another wavelength region may also be employed.

In the example illustrated in the drawing, a configuration in which in the Y direction, the blue dot row unit 22a, the green dot row unit 22b, and the red dot row unit 22c are repeatedly arranged in this order, and, in the X direction, any of the blue dot row units 22a, the green dot row units 22b, and the red dot row units 22c are arranged in a row; however, the invention is not intended to be limited to this, and for example, in the Y direction, any one kind of dot row unit may be arranged in a row, and in the X direction, the blue dot row units 22a, the green dot row units 22b, and the red dot row units 22c may be repeatedly arranged in this order. Alternatively, these dot row units may be arranged randomly.

In the example illustrated in FIG. 4, one dot row unit is constituted of a plurality of dots reflecting light in the same wavelength region, but the invention is not intended to be limited to this, and a configuration in which one dot row unit is constituted of a plurality of dots reflecting light in the different wavelength regions may also be acceptable.

For example, as in the case of the transparent screen 10e illustrated in FIG. 5, a configuration in which a plurality of dot row units 22d are formed by adjacently arranging three dots of the blue dot 20B, the green dot 20G, and the red dot 20R in the Y direction may also be acceptable.

Here, the reflected light of the cholesteric structure of the liquid crystal material that constitutes the dots is circularly polarized light. That is, the cholesteric structure of the liquid crystal material selectively reflects one of right-handed circularly polarized light or left-handed circularly polarized light, and transmits the other.

Therefore, according to the invention, the plurality of dots 20 thus formed may be configured such that all of the dots 20 reflect the same circularly polarized light, or may be configured to include right-handed polarizing dots that reflect right-handed circularly polarized light and left-handed polarizing dots that reflect left-handed circularly polarized light.

In a case where the transparent screen is configured to include dots that reflect right-handed circularly polarized light and dots that reflect left-handed circularly polarized light, it is preferable from the viewpoint that right-handed circularly polarized light and left-handed circularly polarized light of the video light can be reflected, and the reflectance can be increased; from the viewpoint that stereoscopic vision (so-called 3D display) can be implemented by displaying images for the left eye or images for the right eye of a viewer for the right-handed circularly polarized light and the left-handed circularly polarized light, respectively; from the viewpoint that the video light emitted from a video device such as a projector can be utilized even though the video light is right-handed circularly polarized light or left-handed circularly polarized light; and the like.

The circularly polarized light-selective reflectivity concerning whether the reflected light of a cholesteric structure is right-handed circularly polarized light or left-handed circularly polarized light, depends on the direction of twist of the spiral of the cholesteric structure. Selective reflection by a cholesteric liquid crystal occurs such that in a case in which the direction of twist of the spiral of the cholesteric liquid crystal is right-handed, right-handed circularly polarized light is reflected, and in a case in which the direction of twist of the spiral is left-handed, left-handed circularly polarized light is reflected.

It is also acceptable that the transparent screen has two or more kinds of dots that reflect light in the wavelength regions different from each other, and has dots that reflect right-handed circularly polarized light and dots that reflect left-handed circularly polarized light as the dots that reflect light in various wavelength regions.

The example illustrated in FIG. 1A is configured such that each of the various dots reflects light in one wavelength region; however, the invention is not intended to be limited to this, and the transparent screen may also be configured such that a single dot reflects light in a plurality of wavelength regions. That is, the transparent screen may be configured to include dots having two or more regions that reflect light in wavelength regions different from each other in a single dot.

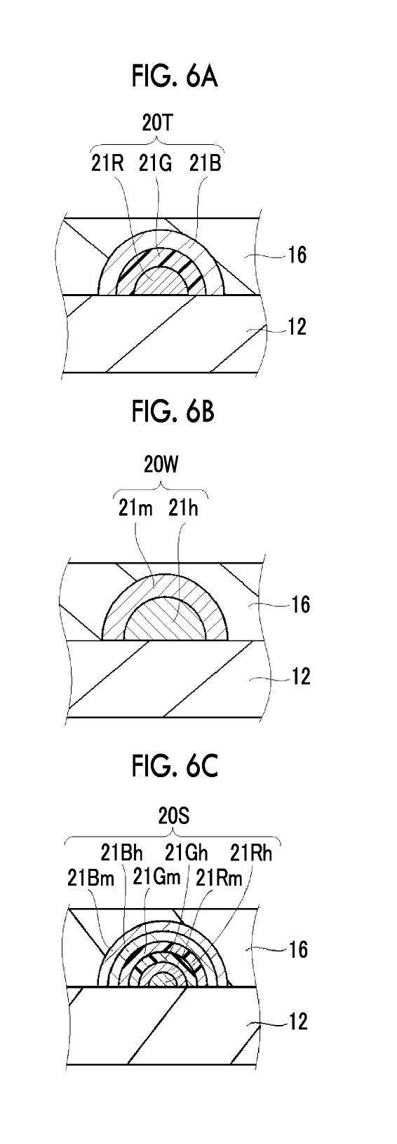

FIG. 6A illustrates a schematic cross-sectional view of another example of the dot utilized in the transparent screen of the invention.

A three-layered dot 20T illustrated in FIG. 6A is a dot with a three-layer structure having a red region 21R that reflects red light, a green region 21G that reflects green light, and a blue region 21B that reflects blue light in a single dot.

Specifically, a three-layered dot 20T has a configuration in which three layers, namely, a red region 21R formed in a hemispheric shape on the substrate 12 side; a green region 21G laminated on the surface of the red region 21R; and a blue region 21B laminated on the surface of the green region 21G, are laminated in the direction of the normal line to the substrate 12.

Since such a three-layered dot 20T has a layer reflecting red light, a layer reflecting green light, and a layer reflecting blue light, red light, green light, and blue light of the incident video light can be reflected with a single dot.

Therefore, the video image projected on the transparent screen can be displayed as a color image. The transparent screen can be utilized even in a case where the video light emitted from a video device such as a projector is red light, or green light, or blue light. Furthermore, red light, green light and blue light of the video light can be reflected, and the reflectance can be enhanced.

The example illustrated in FIG. 6A is configured to have three layers respectively reflecting red light, green light, and blue light; however, the invention is not limited to this, and the configuration may include two layers that reflect light in wavelength regions different from each other, or may include four or more layers.

In the example illustrated in FIG. 6A, the three-layered dot 20T is configured such that a red region 21R, a green region 21G, and a blue region 21B are laminated in this order from the substrate 12 side; however, the invention is not intended to be limited to this, the order of lamination of the various layers may be of any order.

One dot may reflect right-handed circularly polarized light and left-handed circularly polarized light. That is, the transparent screen may be configured to include dots each having a region that reflects right-handed circularly polarized light and a region that reflects left-handed circularly polarized light in a single dot.

FIG. 6B illustrates a schematic cross-sectional view of another example of the dot utilized in the transparent screen of the invention.

A two-layered dot 20W illustrated in FIG. 6B is a dot with a two-layer structure having a right-handed polarizing region 21m that reflects right-handed circularly polarized light and a left-handed polarizing region 21h that reflects left-handed circularly polarized light in a single dot.

Specifically, a two-layered dot 20W has a configuration in which two layers, namely, a left-handed polarizing region 21h formed in a hemispheric shape on the substrate 12 side; and a right-handed polarizing region 21m laminated on the surface of the left-handed polarizing region 21h, are laminated in the direction of the normal line to the substrate 12.

Such a two-layered dot 20W has a layer that reflects right-handed circularly polarized light and a layer that reflects left-handed circularly polarized light, and therefore, the two-layered dot 20W can reflect right-handed circularly polarized light and left-handed circularly polarized light of incident video light with a single dot.

Therefore, right-handed circularly polarized light and left-handed circularly polarized light of video light can be reflected, and the reflectance can be enhanced. Furthermore, stereoscopic vision (so-called 3D display) can be implemented by displaying images for the left eye or images for the right eye of a viewer for the right-handed circularly polarized light and the left-handed circularly polarized light of video light, respectively. Also, the transparent screen can be utilized even in a case where the video light emitted from a video device such as a projector is right-handed circularly polarized light or left-handed circularly polarized light.

In the example illustrated in FIG. 6B, the two-layered dot 20W is configured to have a left-handed polarizing region 21h and a right-handed polarizing region 21m laminated in this order from the substrate 12 side; however, the invention is not intended to be limited to this, and the two-layered dot 20W may also be configured to have a right-handed polarizing region 21m and a left-handed polarizing region 21h laminated in this order.

Furthermore, the various dots may also be configured such that a single dot reflects light in a plurality of wavelength regions, and reflects right-handed circularly polarized light and left-handed circularly polarized light of each of the wavelength regions. That is, the various dots may be configured to include dots each having regions that reflect light in wavelength regions different from each other in a single dot, and having a region that reflects right-handed circularly polarized light and a region that reflects left-handed circularly polarized light for each wavelength region.

FIG. 6C illustrates a schematic cross-sectional view of another example of the transparent screen of the invention.

A six-layered dot 20S illustrated in FIG. 6C is a dot with a six-layer structure having a left-handed polarizing red region 21Rh that reflects red light and left-handed circularly polarized light; a right-handed polarizing red region 21Rm that reflects red light and right-handed circularly polarized light; a left-handed polarizing green region 21Gh that reflects green light and left-handed circularly polarized light; a right-handed polarizing green region 21Gm that reflects green light and right-handed circularly polarized light; a left-handed polarizing blue region 21Bh that reflects blue light and left-handed circularly polarized light; and a right-handed polarizing blue region 21Bm that reflects blue light and right-handed circularly polarized light, in a single dot.

Specifically, the six-layered dot 20S is configured to have six layers such as a left-handed polarizing red region 21Rh formed in a hemispheric shape on the substrate 12 side; a right-handed polarizing red region 21Rm laminated on the surface of the left-handed polarizing red region 21Rh; a left-handed polarizing green region 21Gh laminated on the surface of the right-handed polarizing red region 21Rm; a right-handed polarizing green region 21Gm laminated on the surface of the left-handed polarizing green region 21Gh; a left-handed polarizing blue region 21Bh laminated on the surface of the right-handed polarizing green region 21Gm; and a right-handed polarizing blue region 21Bm laminated on the surface of the left-handed polarizing blue region 21Bh, laminated in the direction of the normal line to the substrate 12.

Since such a six-layered dot 20S has a layer reflecting right-handed circularly polarized light and a layer reflecting left-handed circularly polarized light for red light; a layer reflecting right-handed circularly polarized light and a layer reflecting left-handed circularly polarized light for green light; and a layer reflecting right-handed circularly polarized light and a layer reflecting left-handed circularly polarized light for blue light, the six-layered dot 20S can reflect right-handed circularly polarized light and left-handed circularly polarized light of each of red light, green light, and blue light of incident video light with a single dot.

Therefore, a video image projected on the transparent screen can be displayed as a color image. Also, red light, green light, and blue light of video light, and right-handed circularly polarized light and left-handed circularly polarized light of various wavelength regions can be reflected, and the reflectance can be increased. Furthermore, stereoscopic vision (so-called 3D display) can be implemented by displaying images for the left eye or images for the right eye of a viewer for the right-handed circularly polarized light and the left-handed circularly polarized light of video light, respectively. The transparent screen can be utilized even in a case where the video light emitted from a video device such as a projector is red light, green light, or blue light, or even in a case where the video light is right-handed circularly polarized light or left-handed circularly polarized light.

Next, the materials, shape, and the like of the various constituent elements of the transparent screen of the invention will be described in detail.

[Substrate]

The substrate that is included in the transparent screen of the invention functions as a base material for forming dots on the surface.

It is preferable that the substrate has a low reflectance for light at the wavelength at which the dots reflect light, and it is preferable that the substrate does not include a material that reflects light at the wavelength at which the dots reflect light.

It is also preferable that the substrate is transparent for the visible light region. The substrate may be colored; however, it is preferable that the substrate is not colored or is colored to a low extent. Furthermore, it is preferable that the substrate has a refractive index of about 1.2 to 2.0, and more preferably about 1.4 to 1.8.

In a case where it is said in the present specification that an object is transparent, specifically, the non-polarized light transmittance (omnidirectional transmittance) at a wavelength of 380 to 780 nm may be 50% or higher, may be 70% or higher, and is preferably 85% or higher.

The haze value of the substrate is preferably 30% or lower, more preferably 0.1% to 25%, and particularly preferably 0.1% to 10%.

The thickness of the substrate may be selected according to the applications and is not particularly limited. The thickness may be about 5 μm to 1,000 μm, and is preferably 10 μm to 250 μm, and more preferably 15 μm to 150 μm.

The substrate may be single-layered or may be multilayered, and examples of the substrate in the case of being a single layer substrate include substrates formed of glass, triacetyl cellulose (TAC), polyethylene terephthalate (PET), polycarbonate, polyvinyl chloride, acryl, and a polyolefin. As an example of the substrate in the case of being a multilayered substrate, a substrate that has any one of the examples of the substrate in the case of being a single-layered substrate, as a support, and is provided with another layer on the surface of the support, may be mentioned.

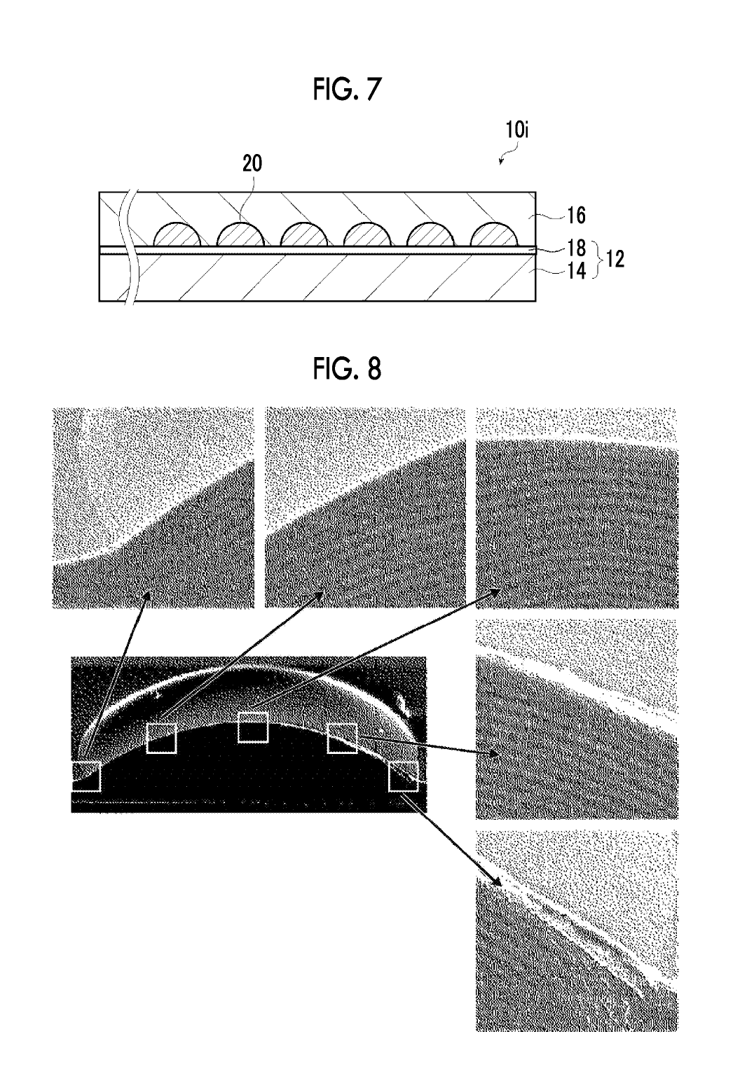

For example, an underlayer 18 may be provided between the support 14 and the dots 20, similarly to the transparent screen 10i illustrated in FIG. 7. The underlayer is preferably a resin layer, and is particularly preferably a transparent resin layer. Examples of the underlayer include a layer for adjusting the surface shape at the time of forming dots, a layer for improving the adhesive characteristics to the dots, and an oriented layer for adjusting the orientation of a polymerizable liquid crystal compound at the time of forming dots.

Regarding the underlayer, it is preferable that the underlayer has a low light reflectance at a wavelength at which the dots reflect light, and it is preferable that the underlayer does not include a material that reflects light at the wavelength at which the dots reflect light. It is also preferable that the underlayer is transparent. Regarding the underlayer, it is preferable that the refractive index is preferably about 1.2 to 2.0, and more preferably about 1.4 to 1.8. It is also preferable that the underlayer is formed of a thermosetting resin or a photocurable resin, which is obtained by curing a composition that is directly applied on the support surface and includes a polymerizable compound. Examples of the polymerizable compound include non-liquid crystal compounds such as a (meth)acrylate monomer and a urethane monomer.

The thickness of the underlayer is not particularly limited, and the thickness is preferably 0.01 to 50 μm, and more preferably 0.05 to 20 μm.

[Dots]

The transparent screen of the invention includes dots formed on the substrate surface. Regarding the substrate surface where dots are formed, the dots may be formed on both surfaces of a substrate, or may be formed on any one surface. In a case in which the dots are formed on both surfaces of a substrate, the reflection intensity can be increased, as the light that has escaped through a portion where dots are not formed on the light incident surface side is reflected at the dots on the back surface side. That is, in a case in which dots are formed on both surfaces of the substrate, it is preferable to form dots on the back surface side at the position where dots are not formed on the front surface side.

A plurality of dots are formed on the substrate surface, and the plurality of dots are arranged so that the plurality of dot row units are formed by setting two or more dots close to each other. The dots may be arranged over the entire surface of the substrate, or may be arranged at least in a partial region of the substrate only.

Here, the array density of the dots is not particularly limited, and may be appropriately set according to the diffusibility (viewing angle), transparency, and the like required for the transparent screen.

From the viewpoint that a balance can be achieved between a wide viewing angle and high transparency, and from the viewpoint of an appropriate density at which dots can be produced without any defects such as coalescence or deletion of dots at the time of production, the area ratio of the dots with respect to the substrate as viewed in the direction of the normal line to a principal surface of the substrate is preferably 1.0% to 90.6%, more preferably 2.0% to 50.0%, and particularly preferably 4.0% to 30.0%.

In regard to the area ratio of the dots, the area ratio in a region having a size of 1 mm×1 mm was measured in an image obtainable with a microscope such as a laser microscope, a scanning electron microscope (SEM) or a transmission electron microscope (TEM), and the average value at 5 sites was designated as the area ratio of the dots.

According to the present specification, in a case where the dots are explained, the explanation is applicable to all the dots in the transparent screen of the invention; however, it is acceptable that the transparent screen of the invention that includes the dots thus explained includes dots that do not apply to the conditions of the same explanation due to deviations or errors that are tolerable in the present technical field.

(Shape of Dots)

The dots may be circular when viewed in the direction of the normal line to a principal surface of the substrate (hereinafter, also referred to as substrate normal line direction). The circular shape may not be a perfect circle, and an approximately circular shape is still acceptable. In a case where the term center is used for a dot, this means the center of this circular shape or the center of gravity. In a case in which there are a large number of dots on the substrate surface, it is desirable that the average shape of the dots is circular, and some dots having a shape that is not considered circular may be included.

The dots are such that the diameter as viewed in the substrate normal line direction is preferably 10 to 200 μm, and more preferably 20 to 120 μm.

The diameter of a dot can be obtained by using an image obtainable with a microscope such as a laser microscope, a scanning electron microscope (SEM) or a transmission electron microscope (TEM), and measuring the length of a straight line that extends from an edge (border or boundary line of a dot) to another edge and passes through the center of the dot. The number of dots and the distance between dots can also be checked from a microscopic image obtained with a laser microscope, a scanning electron microscope (SEM), or a transmission electron microscope (TEM).

In a case in which the shape of the dot is other than a circular shape when viewed in the substrate normal line direction, the diameter of a circle having the same circle area as the projected area of this dot (equivalent circle diameter) is designated as the diameter of the dot.

The dot includes a portion having a height that increases continuously to the maximum height in a direction extending from the edge toward the center of the dot. That is, the dot includes an inclined portion or a curved surface portion having a height increasing from the edge toward the center of the dot. According to the present specification, the above-described portion may be referred to as an inclined portion or a curved surface portion. The inclined portion or curved surface portion represents a portion that is surrounded by a portion of the dot surface extending from a point that starts to increase continuously to a point representing the maximum height, on the dot surface in a cross-sectional view that is perpendicular to the principal surface of the substrate; a straight line that links those points with the substrate by the minimum distance; and the substrate.

According to the present specification, in a case where the term “height” is used for the dot, this means “the minimum distance from a dot on the surface of the dot on the opposite side of the substrate, to the surface of the substrate on the side where the dot is formed”. At this time, the surface of the dot may be an interface with another layer. In a case in which the substrate has surface unevenness, an extension of the substrate surface at the edge of the dot is regarded as the surface on the side where the dot is formed. The maximum height is the maximum value of the height as described above, and for example, the maximum height is the minimum distance from the apex of the dot to the surface of the substrate on the side where the dot is formed. The height of a dot can be checked from a cross-sectional view of the dot that is obtained by focal point scanning by means of a laser microscope, or by using a microscope such as SEM or TEM.

The inclined portion or curved surface portion may be at the edge in the direction of a section as viewed from the center of the dot, or may be at the entirety. For example, in a case where the dot is circular in shape, the edge corresponds to the circumference; however, the edge may be the edge in the direction of a section of the circumference (for example, a part corresponding to a length of 30% or more, 50% or more, 70% or more, and 90% or less of the circumference), or the edge may be an edge in the direction of the entirety of the circumference (90% or more, 95% or more, or 99% or more of the circumference). It is preferable that the edge of a dot is at the entirety. That is, it is preferable that the change in the height in the direction extending from the center of the dot toward the circumference is identical in all directions. Furthermore, it is preferable that the optical properties and the properties explained in a cross-sectional view are also identical in all directions extending from the center toward the circumference.

The inclined portion or curved surface portion may exist at a certain distance that starts from the edge of the dot (border or boundary line of the circumference) but does not reach the center; may extend from the edge of the dot to the center; may exist at a certain distance that starts from a portion at a certain distance from the border (boundary line) of the circumference of the dot but does not reach the center; or may extend from a portion at a certain distance from the edge of the dot, to the center.

A structure that includes the above-described inclined portion or curved surface portion may be, for example, a hemispherical shape having a flat face on the substrate side, a shape that has been flattened by cutting the top of this hemispherical shape approximately in parallel to the substrate (truncated sphere shape), a conical shape having a face on the substrate side as the bottom face, or a shape that has been flattened by cutting the top of this conical shape approximately in parallel to the substrate (truncated cone shape). Among these, preferred shapes include a hemispherical shape having a flat face on the substrate side, a shape that has been flattened by cutting the top of this hemispherical shape approximately in parallel to the substrate, and a shape that has been flattened by cutting the top of a conical shape, which has a face on the substrate side as the bottom face, approximately in parallel to the substrate. The hemispherical shape is meant to include a hemispherical shape having a face including the center of the sphere as a flat face, as well as any of a spherical segment shape obtainable by arbitrarily cutting a sphere into two (preferably a spherical segment shape that does not include the center of the sphere).

The point on the dot surface that gives the maximum height of the dot may be the apex of a hemispherical shape or a conical shape, or may be on the face that has been flattened by cutting approximately in parallel to the substrate as described above. It is also preferable that all of the dots on the flattened face give the maximum height of the dot. It is also preferable that the center of the dot gives the maximum height.

The angle (for example, an average value) formed by the surface of a dot on the opposite side of the substrate and the substrate (surface of the substrate on the side where the dot is formed), that is, the contact angle between the substrate and the dot is preferably 40° or larger, and more preferably 60° or larger. In a case where the contact angle is adjusted to be in this range, a balance between a wide viewing angle and high transparency can be achieved.

The angle can be checked from a cross-sectional view of the dot that is obtained by focal point scanning by means of a laser microscope, or by using a microscope such as SEM or TEM; however, according to the present specification, the angle of the contacting part between the substrate and the dot surface as measured from a cross-sectional view of SEM image at a surface that includes the center of the dot and is perpendicular to the substrate, is employed.

As described above, the contact angle between the substrate and the dot can be adjusted to a desired range by providing an underlayer between the substrate and the dot.

(Optical Properties of Dots)

The dots have wavelength-selective reflectivity. The light for which the dots exhibit selective reflectivity is not particularly limited, and for example, the light may be any of infrared light, visible light, ultraviolet light, and the like. For example, in a case in which the transparent screen is used as a screen that displays an image created by video light emitted from a video device such as projector, and the background on the back surface side of the transparent screen in a superimposed manner, it is preferable that the light for which the dots exhibit selective reflectivity is visible light.

Alternatively, it is also preferable that the reflection wavelength is selected according to the wavelength of light that is emitted from the light source used in combination.

The dots are formed of a liquid crystal material having a cholesteric structure. The wavelength of the light for which the dots exhibit selective reflectivity can be carried out by adjusting the spiral pitch in the cholesteric structure of the liquid crystal material that forms the dots as described above. In the liquid crystal material that forms the dots for the transparent screen of the invention, since the direction of the spiral axis of the cholesteric structure is controlled as will be described below, the incident light is reflected by specular reflection as well as in various directions.

The dots may be colored; however, it is preferable that the dots are not colored, or the dots are colored to a low extent. Thereby, transparency of the transparent screen can be enhanced.

(Cholesteric Structure)

A cholesteric structure is known to exhibit selective reflectivity for a particular wavelength. The center wavelength λ of selective reflection depends on the pitch P of the spiral structure (=period of spiral) in the cholesteric structure, and follows the relation of the average refractive index n of the cholesteric liquid crystal and λ=n×P. Therefore, the selective reflection wavelength can be regulated by regulating this pitch of the spiral structure. Since the pitch of the cholesteric structure depends on the type of the chiral agent used together with a polymerizable liquid crystal compound at the time of forming the dots, or the concentration of addition of the chiral agent, a desired pitch can be obtained by adjusting these. In regard to the adjustment of the pitch, a detailed description is given in Fuji Film Research & Development, No. 50 (2005), p. 60-63. In regard to the method for measuring the sense or pitch of a spiral, the methods described in “Ekisho Kagaku Jikken Nyumon (Introduction to Experiments in Liquid Crystal Chemistry)”, edited by Japanese Liquid Crystal Society, published by Sigma Shuppan K. K., 2007, p. 46; and “Ekisho Benran (Handbook of Liquid Crystals)”, Editorial Committee for the Handbook of Liquid Crystals, Maruzen, Inc., p. 196, can be used.

A cholesteric structure gives a striped pattern of bright parts and dark parts in a cross-sectional view of the dot as observed by a scanning electron microscope (SEM). Two repeated sets of the bright part and the dark part (two bright parts and two dark parts) correspond to one pitch of the spiral. From this, the pitch can be measured from a SEM cross-sectional view. The normal lines to the various lines of the striped pattern become the direction of the spiral axis.

The reflected light of the cholesteric structure is circularly polarized light. That is, the reflected light of the dot in the transparent screen of the invention is circularly polarized light. Regarding the transparent screen of the invention, the applications can be selected while taking this circularly polarized light-selective reflectivity into consideration. Whether the reflected light is right-handed circularly polarized light or left-handed circularly polarized light depends on the direction of twist of the spiral of the cholesteric structure. Selective reflection by the cholesteric liquid crystal occurs such that in a case in which the direction of twist of the spiral of the cholesteric liquid crystal is the right-handed direction, the liquid crystal reflects right-handed circularly polarized light, and in a case in which the direction of twist of the spiral is the left-handed direction, the liquid crystal reflects left-handed circularly polarized light.

According to the invention, a cholesteric liquid crystal having any of right-handed twist and left-handed twist may be used for the dots. Alternatively, it is also preferable that the direction of the circularly polarized light is selected to be the same as the direction of circularly polarized light of the light emitted from the light source used in combination.

The direction of rotation of the cholesteric liquid crystal phase can be adjusted by means of the type of the liquid crystal compound or the type of the chiral agent to be added.

The half-width Δλ (nm) of the selective reflection zone (circularly polarized light reflection zone) that exhibits selective reflection is such that Δλ depends on the birefringence Δn and the pitch P of the liquid crystal compound, and follows the relation of Δλ=Δn×P. Therefore, control of the width of the selective reflection zone can be carried out by adjusting Δn. The adjustment of Δn can be carried out by adjusting the type of the polymerizable liquid crystal compound or the mixing ratio thereof, or by controlling the temperature at the time of orientation immobilization. The half-width of the reflection wavelength zone is adjusted according to the applications of the transparent screen of the invention, and for example, the half-width is desirably 50 to 500 nm, and preferably 100 to 300 nm.

(Cholesteric Structure in Dot)

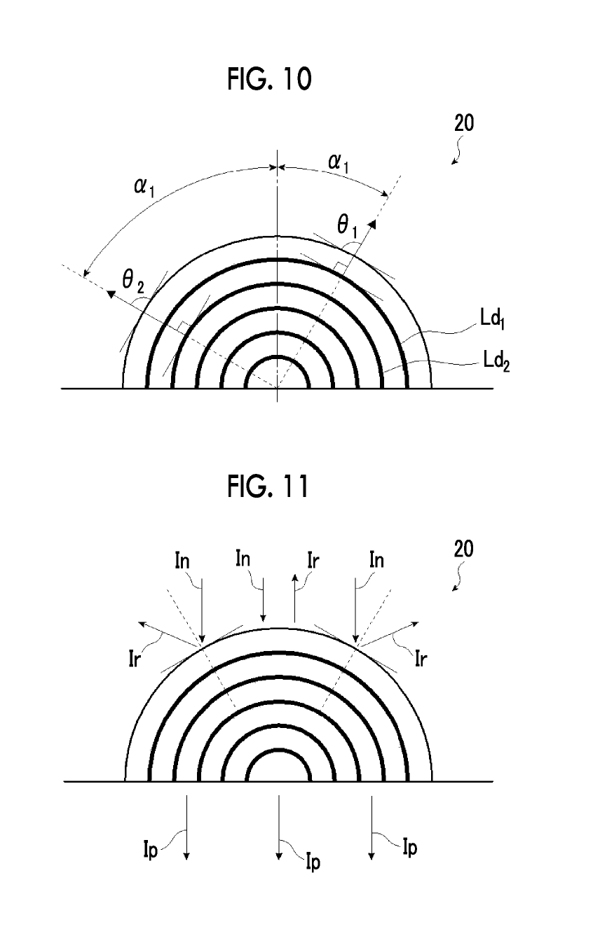

Regarding the dot, in a case where the above-mentioned inclined portion or curved surface portion is checked from a cross-sectional view observed by a scanning electron microscope (SEM), the angle formed by the normal line to a line that is formed by a first one of the dark parts as counted from the surface of the dot on the opposite side of the substrate and the aforementioned surface is in the range of 70° to 90°. FIG. 10 illustrates a schematic diagram of a cross-section of the dot. In this FIG. 10, the line formed by a dark part is represented by a bold line. As illustrated in FIG. 10, the angle θ₁ formed by the normal line to line Ld₁ that is formed by the first dark part and the surface of the dot is 70° to 90°. Here, in a case where the position at the dot surface in the inclined portion or the curved surface portion is represented by angle al with respect to a line perpendicular to the substrate surface that passes through the center of the dot, with the angle α₁ being at the position of 30° and at the position of 60°, it is desirable that the angle formed by the direction of the normal line to line Ld₁ that is formed by the first dark part as counted from the surface of the dot on the opposite side of the substrate and the aforementioned surface is in the range of 70° to 90°. Preferably, it is desirable that for all of the dots at the inclined portion or curved surface portion described above, the angle formed by the direction of the normal line to line Ld₁ that is formed by the first dark part as counted from the surface of the dot on the opposite side of the substrate and the aforementioned surface is in the range of 70° to 90°. That is, it is desirable that the above-mentioned angle is satisfied in some part of the inclined portion or the curved surface portion, for example, it is desirable that the aforementioned angle is satisfied continuously, not that the aforementioned angle is satisfied intermittently in some part of the inclined portion or the curved surface portion. In a case where the surface is curved in the cross-sectional view, the angle formed by the surface means an angle formed by the tangent line of the surface. This angle is indicated as an acute angle, and this means that in a case where the angle formed by the normal line and the surface is indicated as an angle of 0° to 180°, the range of angle is 70° to 110°. In regard to the cross-sectional view, it is preferable that all of the lines formed by up to the second dark part as counted from the surface of the dot on the opposite side of the substrate are such that the angle formed by the normal line of the lines, and the aforementioned surface, is in the range of 70° to 90°; it is more preferable that all of the lines formed by up to the 3^{rd} or 4^{th} dark part as counted from the surface of the dot on the opposite side of the substrate are such that the angle formed by the normal line of the lines and the aforementioned surface is in the range of 70° to 90°; and it is even more preferable that all of the lines formed by up to the 5^{th} to 12^{th} dark part as counted from the surface of the dot on the opposite side of the substrate are such that the angle formed by the normal line of the lines and the aforementioned surface is in the range of 70° to 90°.

The angle is preferably in the range of 80° to 90°, and more preferably in the range of 85° to 90°.

Furthermore, it is preferable that the angle θ₂ formed by the normal line to line Ld₂ that is formed by the second dark part as counted from the surface of the dot on the opposite side of the substrate and the aforementioned surface is in the range of 70° to 90°, and it is preferable that the angle formed by the normal line of the lines formed by the 3^{rd} to 20^{th} dark part and the aforementioned surface is also in the range of 70° to 90°.

The cross-sectional view provided by SEM shows that at the surface of the dot in the inclined portion or the curved surface portion, the spiral axis of the cholesteric structure forms an angle in the range of 70° to 90° with the surface. Due to such a structure, regarding the light entering into the dot, the light entering in the direction that forms an angle in the direction of the normal line to the substrate can be caused to enter at an angle close to be parallel to the direction of the spiral axis of the cholesteric structure at the inclined portion or the curved surface portion. Therefore, the light entering into the dot can be reflected in various directions. Specifically, since the dot causes specular reflection of incident light relative to the spiral axis of the cholesteric structure, as illustrated in FIG. 11, with respect to light In entering in the direction of the normal line to the substrate, reflected light Ir that is reflected in the vicinity of the center of the dot is reflected in parallel to the direction of the normal line to the substrate. Meanwhile, at a position shifted from the center of the dot (position at which the spiral axis of the cholesteric structure is shifted relative to the direction of the normal line to the substrate), the reflected light Ir is reflected in a direction that is different from the direction of the normal line to the substrate. Therefore, the light entering into the dot can be reflected in various directions, and the viewing angle can be widened. Since the light Ip that is transmitted through the dot is transmitted in the same direction as the incident light In, scattering of the transmitted light is suppressed, the haze can be lowered, and transparency can be increased.

It is also preferable that the light entering in the direction of the normal line to the substrate can be reflected in all directions. Particularly, it is preferable that the angle (half-value angle) at which the brightness becomes half the front surface brightness (peak brightness) can be set to 35° or larger, and the transparent screen has high reflectivity.

At the surface of the dot in the inclined portion or the curved surface portion, since the spiral axis of the cholesteric structure and the surface form an angle in the range of 70° to 90°, it is preferable that the angle formed by the direction of the normal line to a line that is formed by the first dark part as counted from the surface and the direction of the normal line to the substrate decreases continuously as the height increases continuously.

The cross-sectional view is a cross-sectional view in an arbitrary direction including a portion having a height that increases continuously to the maximum height in the direction extending from the edge of the dot toward the center, and typically, the cross-sectional view is desirably a cross-sectional view of any arbitrary surface that includes the center of the dot and is perpendicular to the substrate.

(Method for Producing Cholesteric Structure)

A cholesteric structure can be obtained by immobilizing a cholesteric liquid crystal phase. The structure in which a cholesteric liquid crystal phase is immobilized may be a structure in which the orientation of the liquid crystal compound that forms the cholesteric liquid crystal phase is retained, and typically, the structure may be a structure in which a polymerizable liquid crystal compound is brought into an oriented state of the cholesteric liquid crystal phase and then is polymerized and cured by ultraviolet irradiation, heating or the like, and a layer lacking fluidity is formed and simultaneously changed into a state that is free of any factor causing a change in the oriented state by an external field or an external force. Meanwhile, in regard to the structure obtained by immobilizing the cholesteric liquid crystal phase, it is sufficient in a case where the optical properties of the cholesteric liquid crystal phase are retained, and it is acceptable in a case where the liquid crystal compound has already stopped exhibiting liquid crystal properties. For example, it is acceptable that the polymerizable liquid crystal compound is macromolecularized by a curing reaction and thereby has already lost liquid crystallinity.

The material used for forming the cholesteric structure may be a liquid crystal composition including a liquid crystal compound. The liquid crystal compound is preferably a polymerizable liquid crystal compound.

The liquid crystal composition including a polymerizable liquid crystal compound further includes a surfactant. The liquid crystal composition may further include a chiral agent and a polymerization initiator.

—Polymerizable Liquid Crystal Compound—

The polymerizable liquid crystal compound may be a rod-like liquid crystal compound or a disc-like liquid crystal compound; however, it is preferable that the liquid crystal compound is a disc-like liquid crystal compound.

Examples of a rod-like polymerizable liquid crystal compound that forms a cholesteric liquid crystal layer include a rod-like nematic liquid crystal compound. As the rod-like nematic liquid crystal compound, azomethines, azoxys, cyanobiphenyls, cyanophenyl esters, benzoic acid esters, cyclohexanecarboxylic acid phenyl esters, cyanophenylcyclohexanes, cyano-substituted phenylpyrimidines, alkoxy-substituted phenylpyrimidines, phenyldioxanes, tolanes, and alkenylcyclohexylbenzonitriles are preferably used. Low molecular weight liquid crystal compounds as well as polymeric liquid crystal compounds can be used.

A polymerizable liquid crystal compound can be obtained by introducing a polymerizable group into a liquid crystal compound. Examples of the polymerizable group include an unsaturated polymerizable group, an epoxy group, and an aziridinyl group, and an unsaturated polymerizable group is preferred, while an ethylenically unsaturated polymerizable group is particularly preferred. A polymerizable group can be introduced into a molecule of a liquid crystal compound by various methods. The number of polymerizable groups that a polymerizable liquid crystal compound can have is preferably 1 to 6, and more preferably 1 to 3. Examples of the polymerizable liquid crystal compound include the compounds described in Makromol. Chem., Vol. 190, p. 2255 (1989); Advanced Materials, Vol. 5, p. 107 (1993); U.S. Pat. No. 4,683,327A, U.S. Pat. No. 5,622,648A, U.S. Pat. No. 5,770,107A, WO95/22586A, WO95/24455A, WO97/00600A, WO98/23580A, WO98/52905A, JP1989-272551A (JP-H01-272551A), JP1994-16616A (JP-H06-16616A), JP1995-110469A (JP-H07-110469A), JP1999-80081A (JP-H11-80081A), and JP2001-328973A. Two or more kinds of polymerizable liquid crystal compounds may be used in combination. In a case where two or more kinds of polymerizable liquid crystal compounds are used in combination, the orientation temperature can be lowered.

Specific examples of the polymerizable liquid crystal compound include compounds represented by General Formulae (1) to (11).

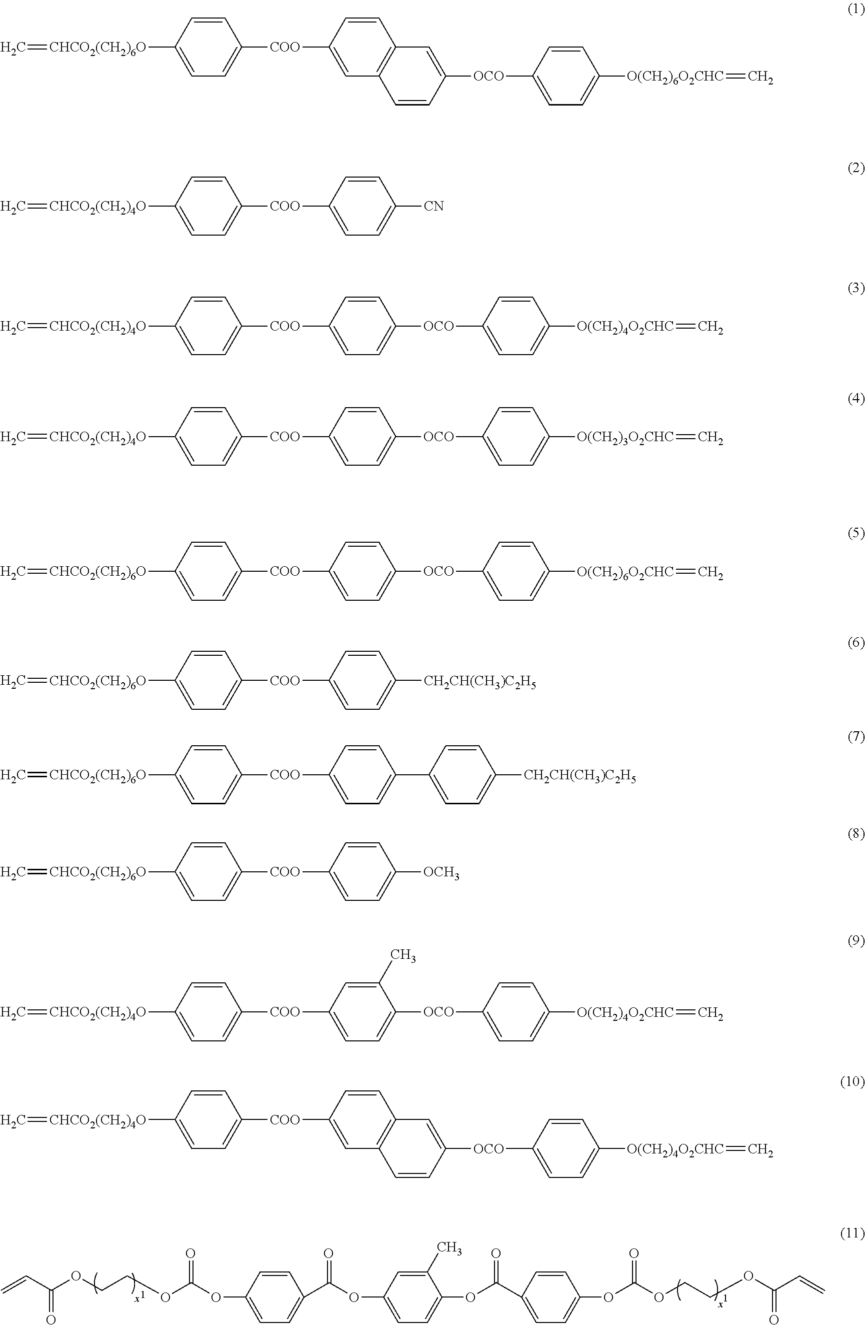

[wherein in Compound (11), X¹ is 2 to 5 (integer).]

As a polymerizable liquid crystal compound other than those described above, cyclic organopolysiloxane compounds having a cholesteric phase as disclosed in JP1982-165480A (JP-S57-165480A), and the like can be used. Furthermore, regarding the polymeric liquid crystal compound described above, a polymer in which a mesogenic group that exhibits liquid crystallinity has been introduced into a position at the main chain, a side chain, or both of the main chain and a side chain; a polymer cholesteric liquid crystal in which a cholesteryl group has been introduced into a side chain; the liquid crystalline polymer disclosed in JP1997-133810A (JP-H09-133810A); the liquid crystalline polymer disclosed in JP1999-293252A (JP-H11-293252A), and the like can be used.

The amount of addition of the polymerizable liquid crystal compound in the liquid crystal composition is preferably 75% to 99.9% by mass, more preferably 80% to 99% by mass, and particularly preferably 85% to 90% by mass, with respect to the solid content mass (mass excluding the solvent) of the liquid crystal composition.

—Surfactant—

The inventors found that by adding a surfactant to the liquid crystal composition that is used in a case where dots are formed, the polymerizable liquid crystal compound is horizontally oriented on the air interface side at the time of forming the dots, and dots having the direction of the spiral axis controlled as explained above are obtained. Generally, for the purpose of forming the dots, it is necessary not to lower the surface tension in order to maintain the liquid droplet shape at the time of printing. Therefore, it is surprising that it is possible to form dots even in a case where a surfactant is added, and dots having high recursive reflectivity in multiple directions are obtained. In the Examples described below, it is shown that in a transparent screen manufactured by using a surfactant, a dot in which the angle formed by the dot surface and the substrate at the dot edge is 40° or larger is fanned. That is, it is understood that by adding a surfactant at the time of forming a dot, the contact angle between the dot and the substrate can be formed in an angle range by which a balance between a wide viewing angle and high transparency can be achieved.

The surfactant is preferably a compound capable of functioning as an orientation controlling agent that contributes in order to obtain a cholesteric structure with planar orientation stably and rapidly. Examples of the surfactant include silicone-based surfactants and fluorine-based surfactants, and fluorine-based surfactants are preferred.

Specific examples of the surfactant include the compounds described in paragraphs [0082] to [0090] of JP2014-119605A, the compounds described in paragraphs [0031] to [0034] of JP2012-203237A, the compounds listed as examples in paragraphs [0092] and [0093] of JP2005-99248A, the compounds listed as examples in paragraphs [0076] to [0078] and paragraphs [0082] to [0085] of JP2002-129162A, and the fluoro(meth)acrylate-based polymers described in paragraphs [0018] to [0043] of JP2007-272185A.

As the horizontal orientation agent, one kind of agent may be used singly, or two or more kinds of agents may be used in combination.

As the fluorine-based surfactant, a compound represented by General Formula (I) described in paragraphs [0082] to [0090] of JP2014-119605A is particularly preferred.

(Hb¹¹-Sp¹¹-L¹¹-Sp¹²-L¹²)ₘ₁₁-A¹¹-L¹³-T¹¹-L¹⁴-A¹²-(L¹⁵-Sp¹³-L¹⁶-Sp¹⁴-Hb¹¹)ₙ₁₁ General Formula (I)

In General Formula (I), L¹¹, L¹², L¹³, L¹⁴, L¹⁵, and L¹⁶ each independently represent a single bond, —O—, —S—, —CO—, —COO—, —OCO—, —COS—, —SCO—, —NRCO—, or —CONR— (wherein R in General Formula (I) represents a hydrogen atom or an alkyl group having 1 to 6 carbon atoms). —NRCO— and —CONR— have an effect of lowering solubility. —O—, —S—, —CO—, —COO—, —OCO—, —COS—, or —SCO— is more preferable, from the viewpoint of having a tendency that the haze increases at the time of producing dots, and —O—, —CO—, —COO—, or —OCO— is even more preferable, from the viewpoint of stability of the compound. The alkyl group that can be adopted by R may be linear or branched. The number of carbon atoms is more preferably 1 to 3, and examples include a methyl group, an ethyl group, and an n-propyl group.

Sp¹¹, Sp¹², Sp¹³, and Sp¹⁴ each independently represent a single bond or an alkylene group having 1 to 10 carbon atoms, and are each more preferably a single bond or an alkylene group having 1 to 7 carbon atoms, and even more preferably a single bond or an alkylene group having 1 to 4 carbon atoms. However, the hydrogen atoms of the alkylene group may be substituted by fluorine atoms. The alkylene group may or may not be branched; however, an unbranched, linear alkylene group is preferred. From the viewpoint of synthesis, it is preferable that Sp¹¹ and Sp¹⁴ are identical, while Sp¹² and Sp¹³ are identical.

A¹¹ and A¹² each represent a monovalent to tetravalent aromatic hydrocarbon group. The number of carbon atoms of the aromatic hydrocarbon group is preferably 6 to 22, more preferably 6 to 14, even more preferably 6 to 10, and still more preferably 6. The aromatic hydrocarbon group represented by A¹¹ or A¹² may have a substituent. Examples of such a substituent include an alkyl group having 1 to 8 carbon atoms, an alkoxy group, a halogen atom, a cyano group, and an ester group. Regarding an explanation on these groups and preferred ranges thereof, reference can be made to the description concerning the following T. Examples of the substituent for the aromatic hydrocarbon group represented by A¹¹ or A¹² include a methyl group, an ethyl group, a methoxy group, an ethoxy group, a bromine atom, a chlorine atom, and a cyano group. A molecule having many perfluoroalkyl moieties in the molecule can orient liquid crystal molecules even in a case of being added in a small amount, and since this leads to a decrease in the haze, it is preferable that A¹¹ and A¹² are tetravalent so as to have more many perfluoroalkyl groups in the molecule. From the viewpoint of synthesis, it is preferable that A¹¹ and A¹² are identical.

It is preferable that T¹¹ represents a divalent group represented by

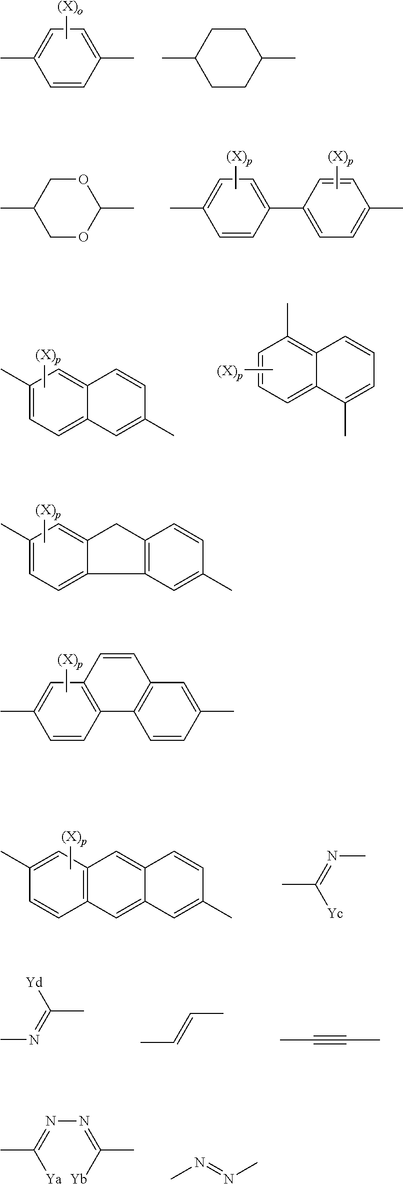

or a divalent aromatic heterocyclic group (wherein X included in T¹¹ represents an alkyl group having 1 to 8 carbon atoms, an alkoxy group, a halogen atom, a cyano group, or an ester group; and Ya, Yb, Yc, and Yd each independently represent a hydrogen atom or an alkyl group having 1 to 4 carbon atoms), and T¹¹ is more preferably,

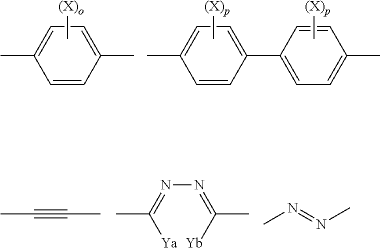

and even more preferably,

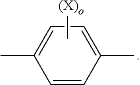

The number of carbon atoms of the alkyl group that can be adopted by X included in T¹¹ is 1 to 8, preferably 1 to 5, and more preferably 1 to 3. The alkyl group may be any of a linear group, a branched group, and a cyclic group, and the alkyl group is preferably a linear or branched group. Preferred examples of the alkyl group include a methyl group, an ethyl group, an n-propyl group, and an isopropyl group, and among them, a methyl group is preferred. For the alkyl moiety of the alkoxy group that can be adopted by X included in T¹¹, reference can be made to the explanation and preferred range for the alkyl group that can be adopted by X included in T¹¹. Examples of the halogen atom that can be adopted by X include in T¹¹ include a fluorine atom, a chlorine atom, a bromine atom, and an iodine atom, and a chlorine atom and a bromine atom are preferred. Examples of the ester group that can be adopted by X included in T¹¹ include a group represented by R′COO—. R′ may be an alkyl group having 1 to 8 carbon atoms. Regarding the explanation and a preferred range for the alkyl group that can be adopted by R′, reference can be made to the explanation and preferred range for the alkyl group that can be adopted by X included in T¹¹. Specific examples of the ester include CH₃COO— and C₂H₅COO—. The alkyl group having 1 to 4 carbon atoms that can be adopted by Ya, Yb, Yc, and Yd may be a linear group or a branched group. Examples thereof include a methyl group, an ethyl group, an n-propyl group, and an isopropyl group.

It is preferable that the divalent aromatic heterocyclic group has a 5-membered, 6-membered, or 7-membered heterocyclic ring. A 5-membered ring or a 6-membered ring is more preferred, and a 6-membered ring is most preferred. Preferred examples of the heteroatom that constitutes the heterocyclic ring include a nitrogen atom, an oxygen atom, and a sulfur atom. The heterocyclic ring is preferably an aromatic heterocyclic ring. The aromatic heterocyclic ring is generally an unsaturated heterocyclic ring. An unsaturated heterocyclic ring having the largest number of double bonds is more preferred. Examples of the heterocyclic ring include a furan ring, a thiophene ring, a pyrrole ring, a pyrroline ring, a pyrrolidine ring, an oxazole ring, an isoxazole ring, a thiazole ring, an isothiazole ring, an imidazole ring, an imidazoline ring, an imidazolidine ring, a pyrazole ring, a pyrazoline ring, a pyrazolidine ring, a triazole ring, a furazan ring, a tetrazole ring, a pyran ring, a thiine ring, a pyridine ring, a piperidine ring, an oxazine ring, a morpholine ring, a thiazine ring, a pyridazine ring, a pyrimidine ring, a pyrazine ring, a piperazine ring, and a triazine ring. The divalent heterocyclic group may have a substituent. Regarding the explanation and preferred ranges for the examples of the substituent, reference can be made to the explanation and description related to the substituent that can be adopted by the monovalent to tetravalent aromatic hydrocarbon of A¹ and A².

Hb¹¹ represents a perfluoroalkyl group having 2 to 30 carbon atoms, and Hb¹¹ is more preferably a perfluoroalkyl group having 3 to 20 carbon atoms, and even more preferably a perfluoroalkyl group having 3 to 10 carbon atoms. The perfluoroalkyl group may be any of a linear group, a branched group, and a cyclic group; however, the perfluoroalkyl group is preferably a linear or branched group, and more preferably a linear group.

m11 and n11 each independently represent 0 to 3, and m11+n11≧1. At this time, a plurality of the structures described within the parentheses may be identical with or different from each other; however, it is preferable that the structures are identical with each other. m11 and n11 in General Formula (I) are determined based on the valence of A¹¹ and A¹², and preferred ranges thereof are also determined based on the preferred ranges for the valence of A¹¹ and A¹².

o and p included in T¹¹ each independently represent an integer of 0 or larger, and in a case where o and p are 2 or larger, the plurality of X's may be identical with or different from each other. o included in T¹¹ is preferably 1 or 2. p included in T¹¹ is preferably an integer of 1 to 4, and more preferably 1 or 2.

The compound represented by General Formula (I) is such that the molecular structure may have symmetry, or may not have symmetry. The term symmetry as used herein means that the molecular structure corresponds to at least any one of point symmetry, line symmetry, and rotational symmetry, and the term asymmetry means that the molecular structure does not correspond to any of point symmetry, line symmetry, and rotational symmetry.

The compound represented by General Formula (I) is a compound in which the perfluoroalkyl group (Hb¹¹) described above, linking groups -(-Sp¹¹-L¹¹-Sp¹²-L¹²)m₁₁-A¹¹-L¹³- and -L¹⁴-A¹²-(L¹⁵-Sp¹³-L¹⁶-Sp¹⁴)n₁₁-, and T, which is preferably a divalent group having an excluded volume effect, are combined. It is preferable that the two perfluoroalkyl group (Hb¹¹) existing in the molecule are identical with each other, and it is also preferable that the linking groups -(-Sp¹¹-L¹¹-Sp¹²-L¹²)m₁₁-A¹¹-L¹³- and -L¹⁴-A¹²-(L¹⁵-Sp¹³-L¹⁶-Sp¹⁴)n₁₁ - existing in the molecule are also identical with each other. It is preferable that terminal Hb¹¹-Sp¹¹-L¹¹-Sp¹²- and -Sp¹³-L¹⁶-Sp¹⁴-Hb¹¹ are groups represented by any of the following general formulae.

(CₐF₂ₐ₊₁)—(C_{b}H_{2b})—

(CₐF₂ₐ₊₁)—(C_{b}H_{2b})—O—(CᵣH_{2r)—}

(CₐF₂ₐ₊₁)—(C_{b}H_{2b})—COO—(CᵣH₂ᵣ)—

(CₐF₂ₐ₊₁)—(C_{b}H_{2b})—OCO—(CᵣH₂ᵣ)—

In the above formulae, a is preferably 2 to 30, more preferably 3 to 20, and even more preferably 3 to 10. b is preferably 0 to 20, more preferably 0 to 10, and even more preferably 0 to 5. a+b is 3 to 30. r is preferably 1 to 10, and more preferably 1 to 4.

Furthermore, it is preferable that the terminal Hb¹¹-Sp¹¹-L¹¹-Sp¹²-L¹²- and -L¹⁵-Sp¹³-L¹⁶-Sp¹⁴-Hb¹¹ in General Formula (I) are each a group represented by any of the following general formulae.

(CₐF₂ₐ₊₁)—(C_{b}H_{2b})—O—

(CₐF₂ₐ₊₁)—(C_{b}H_{2b})—COO—

(CₐF₂ₐ₊₁)—(C_{b}H_{2b})—O—(CᵣH₂ᵣ)—O—

(CₐF₂ₐ₊₁)—(C_{b}H_{2b})—COO—(CᵣH₂ᵣ)—COO—

(CₐF₂ₐ₊₁)—(C_{b}H_{2b})—OCO—(CᵣH₂ᵣ)—COO—

The definitions of a, b, and r in the above formulae are the same as the definitions given right above.

The amount of addition of the surfactant in the liquid crystal composition is preferably 0.01% by mass to 10% by mass, more preferably 0.01% by mass to 5% by mass, and particularly preferably 0.02% by mass to 1% by mass, with respect to the total mass of the polymerizable liquid crystal compound.

—Chiral Agent (Optically Active Compound)—

A chiral agent has a function of creating a spiral structure of the cholesteric liquid crystal phase. Since chiral compounds have different directions of twist of the spiral or different pitches of the spiral created by the compounds, the chiral compound may be selected according to the purpose.

There are no particular limitations on the chiral agent, and known compounds (for example, described in Handbook of Liquid Crystal Devices, Chapter 3, Section 4-3, Chiral agents for TN and STN, p. 199, edited by the 142^{nd} Committee of Japan Society for the Promotion of Science (1989)), isosorbide, and isomannide derivatives can be used.

A chiral agent generally includes an asymmetric carbon atom; however, an axially asymmetric compound or a plane-asymmetric compound, which does not include an asymmetric carbon atom, can also be used as a chiral agent. Examples of the axially asymmetric compound or plane-asymmetric compound include binaphthyl, helicene, paracyclophane, and derivatives thereof. The chiral agent may have a polymerizable group. In a case in which both the chiral agent and the liquid crystal compound have a polymerizable group, a polymer having a repeating unit derived from a polymerizable liquid crystal compound and a repeating unit derived from a chiral agent can be formed by a polymerization reaction between the polymerizable chiral agent and the polymerizable liquid crystal compound. In the aspect, it is preferable that the polymerizable group of the polymerizable chiral agent is a group of the same kind as the polymerizable group of the polymerizable liquid crystal compound. Therefore, it is preferable that the polymerizable group of the chiral agent is also an unsaturated polymerizable group, an epoxy group, or an aziridinyl group; more preferably an unsaturated polymerizable group; and particularly preferably an ethylenically unsaturated polymerizable group.

The chiral agent may also be a liquid crystal compound.

In a case in which the chiral agent has a photoisomerizable group, it is preferable since a desired pattern of reflection wavelength corresponding to the emitted light wavelength can be formed by photomask irradiation with active light rays or the like after application and orientation. The photoisomerizable group is preferably an isomerization site of a compound exhibiting photochromic properties, an azo group, an azoxy group, or a cinnamoyl group. Specific compounds that can be used include the compounds described in JP2002-80478A, JP2002-80851A, JP2002-179668A, JP2002-179669A, JP2002-179670A, JP2002-179681A, JP2002-179682A, JP2002-338575A, JP2002-338668A, JP2003-313189A, and JP2003-313292A.

Specific examples of the chiral agent include a compound represented by Formula (12).

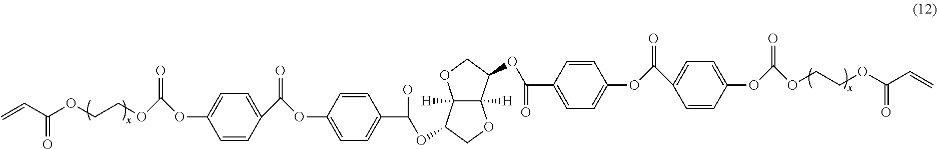

wherein X represents 2 to 5 (integer).

The content of the chiral agent in the liquid crystal composition is preferably 0.01 mol % to 200 mol %, and more preferably 1 mol % to 30 mol %, of the amount of the polymerizable liquid crystal compound.

—Polymerization Initiator—

In a case in which a polymerizable compound is included in the liquid crystal composition, it is preferable that the liquid crystal composition includes a polymerization initiator. In an aspect of carrying out a polymerization reaction by ultraviolet irradiation, the polymerization initiator to be used is preferably a photopolymerization initiator capable of initiating the polymerization reaction by ultraviolet irradiation. Examples of the photopolymerization initiator include α-carbonyl compounds (described in U.S. Pat. No. 2,367,661A and U.S. Pat. No. 2,367,670A), acyloin ethers (described in U.S. Pat. No. 2,448,828A), α-hydrocarbon-substituted aromatic acyloin compounds (described in U.S. Pat. No. 2,722,512A), polynuclear quinone compounds (described in U.S. Pat. No. 3,046,127A and U.S. Pat. No. 2,951,758A), combinations of a triarylimidazole dimer and p-aminophenyl ketone (described in U.S. Pat. No. 3,549,367A), acridine and phenazine compounds (described in JP1985-105667A (JP-S60-105667A) and U.S. Pat. No. 4,239,850A), and oxadiazole compounds (described in U.S. Pat. No. 4,212,970A).

The content of the photopolymerization initiator in the liquid crystal composition is preferably 0.1% to 20% by mass, and more preferably 0.5% by mass to 12% by mass, with respect to the content of the polymerizable liquid crystal compound.

—Crosslinking Agent—

The liquid crystal composition may optionally include a crosslinking agent for the purpose of enhancing the film hardness after curing and enhancing durability. Regarding the crosslinking agent, an agent capable of curing by means of ultraviolet radiation, heat, moisture, or the like can be suitably used.

The crosslinking agent is not particularly limited and can be appropriately selected according to the purpose. Examples include polyfunctional acrylate compounds such as trimethylolpropane tri(meth)acrylate and pentaerythritol tri(meth)acrylate; epoxy compounds such as glycidyl (meth)acrylate and ethylene glycol diglycidyl ether; aziridine compounds such as 2,2-bishydroxymethylbutanol tris [3-(1-aziridinyl) propionate] and 4,4-bis(ethyleneiminocarbonylamino)diphenylmethane; isocyanate compounds such as hexamethylene diisocyanate and biuret type isocyanate; polyoxazoline compounds having an oxazoline group in a side chain; and alkoxysilane compounds such as vinyltrimethoxysilane and N-(2-aminoethyl)-3-aminopropyltrimethoxysilane. Furthermore, a known catalyst can be used according to the reactivity of the crosslinking agent, and thus productivity can be enhanced in addition to the enhancement of film hardness and durability. These may be used singly, or two or more kinds thereof may be used in combination.

The content of the crosslinking agent is preferably 3% by mass to 20% by mass, and more preferably 5% by mass to 15% by mass. In a case where the content of the crosslinking agent is less than 3% by mass, an effect of increasing the crosslinking density may not be obtained, and in a case where the content is more than 20% by mass, stability of the cholesteric liquid crystal layer may be deteriorated.

—Other Additives—

In the case of using the inkjet method that will be described below as the method for forming dots, a monofunctional polymerizable monomer may be used in order to obtain ink properties that are generally required. Examples of the monofunctional polymerizable monomer include 2-methoxyethyl acrylate, isobutyl acrylate, isooctyl acrylate, isodecyl acrylate, and octyl/decyl acrylate.

The liquid crystal composition may further include, if necessary, a polymerization inhibitor, an antioxidant, an ultraviolet absorber, a photostabilizer, a coloring material, and metal oxide fine particles, to the extent that the optical performance and the like are not deteriorated.

It is preferable that the liquid crystal composition is used as a liquid at the time of forming the dots.

The liquid crystal composition may include a solvent. The solvent is not particularly limited and can be appropriately selected according to the purpose; however, an organic solvent is preferably used.

The organic solvent is not particularly limited and can be appropriately selected according to the purpose. Examples thereof include ketones such as methyl ethyl ketone and methyl isobutyl ketone; alkyl halides, amides, sulfoxides, heterocyclic compounds, hydrocarbons, esters, and ethers. These may be used singly or in combination of two or more kinds thereof Among these, in a case where the environmental burden is taken into consideration, ketones are particularly preferred. The above-mentioned components such as the monofunctional polymerizable monomer may also function as the solvent.

The liquid crystal composition is applied onto a substrate and then is cured. Thus, dots are formed. Application of the liquid crystal composition onto the substrate is preferably carried out by applying as droplets. In a case where a plurality (usually, a large number) of dots are applied onto the substrate, printing by using the liquid crystal composition as an ink may be carried out. The printing method is not particularly limited, and an inkjet method, a gravure printing method, a flexographic printing method, and the like can be used; however, an inkjet method is particularly preferred. A pattern of dots can also be formed by applying a known printing technology.

As illustrated in FIG. 6A to FIG. 6C, in the case of a dot having a plurality of regions that reflect light in wavelength regions different from each other in a single dot, or in the case of a dot having a layer reflecting right-handed circularly polarized light and a region reflecting left-handed circularly polarized light in a single dot, first, a first layer is formed by applying as droplets a liquid crystal composition that becomes a layer on the substrate side by the above-mentioned printing method and curing the liquid crystal composition, and then a second layer is formed by applying as droplets a liquid crystal composition that becomes a second layer over the first layer and curing the liquid crystal composition. Furthermore, a third layer and so forth are also formed by the same method. Thereby, a dot having a plurality of regions having different wavelength regions or directions of polarization of reflected light can be formed.

The liquid crystal composition after being applied onto the substrate is dried or heated as necessary, and then is cured. It is desirable in a case where the polymerizable liquid crystal compound in the liquid crystal composition is oriented by the process of drying or heating. In the case of performing heating, the heating temperature is preferably 200° C. or lower, and more preferably 130° C. or lower.

The liquid crystal compound thus oriented may be further polymerized. Polymerization may be any of thermal polymerization and photopolymerization based on light irradiation; however, photopolymerization is preferred. It is preferable to use ultraviolet radiation for light irradiation. The irradiation energy is preferably 20 mJ/cm² to 50 J/cm², and more preferably 100 mJ/cm² to 1,500 mJ/cm². In order to accelerate the photopolymerization reaction, light irradiation may be carried out under heating conditions or in a nitrogen atmosphere. The wavelength of ultraviolet radiation radiated is preferably 250 nm to 430 nm. The polymerization reaction ratio is preferably higher from the viewpoint of stability, and the polymerization reaction ratio is preferably 70% or higher, and more preferably 80% or higher.

The polymerization reaction ratio can be determined by determining the consumption ratio of the polymerizable functional group using an IR absorption spectrum.

[Overcoat Layer]

The transparent screen may include an overcoat layer. The overcoat layer may be provided on the surface of the substrate where the dots have been formed, and it is preferable that the overcoat layer flattens the surface of the transparent screen.

The overcoat layer is not particularly limited; however, as described above, it is preferable as the difference in the refractive index between the overcoat layer and the dots is smaller, and it is preferable that the difference in the refractive index is 0.04 or less. Since the refractive index of the dots formed of a liquid crystal material is about 1.6, it is preferable that the overcoat layer is a resin layer having a refractive index of about 1.4 to 1.8. By using an overcoat layer having a refractive index that is close to the refractive index of the dots, the angle of light that actually enters into the dot from the normal line (polar angle) can be made smaller. For example, in a case where light is caused to enter the transparent screen at a polar angle of 45° using an overcoat layer having a refractive index of 1.6, the polar angle of light that actually enters the dot can be adjusted to about 27°. Therefore, by using an overcoat layer, the polar angle of light at which the transparent screen exhibits recursive reflectivity can be extended, and even for a dot having a small angle formed by the surface of the dot on the opposite side of the substrate and the substrate, higher recursive reflectivity can be obtained in a wider range. The overcoat layer may also have a function as an antireflective layer, a pressure-sensitive adhesive layer, an adhesive layer, or a hard coat layer.

An example of the overcoat layer may be a resin layer obtainable by applying a composition including a monomer on the surface of the substrate where dots have been formed, and then curing the coating film. The resin is not particularly limited, and the resin may be selected in consideration of adhesiveness to the substrate or the liquid crystal material with which the dots are formed, or the like. For example, a thermoplastic resin, a thermosetting resin, and an ultraviolet-curable resin can be used. In view of durability, solvent resistance, and the like, a resin of the type that is cured by crosslinking is preferred, and particularly, an ultraviolet-curable resin that can be cured in a short period of time is preferred. Examples of the monomer that can be used to form the overcoat layer include ethyl (meth)acrylate, ethylhexyl (meth)acrylate, styrene, methylstyrene, N-vinylpyrrolidone, polymethylolpropane tri(meth)acrylate, hexanediol (meth)acrylate, tripropylene glycol di(meth)acrylate, diethylene glycol di(meth)acrylate, pentaerythritol tri(meth)acrylate, dipentaerythritol hexa(meth)acrylate, 1,6-hexanediol di(meth)acrylate, and neopentyl glycol di(meth)acrylate.

The thickness of the overcoat layer is not particularly limited, and may be determined in consideration of the maximum height of the dot. The thickness may be about 5 μm to 100 μm, preferably 10 μm to 50 μm, and more preferably 20 μm to 40 μm. The thickness is the distance from the dot-formed surface of the substrate in the area where there are no dots, to the surface of the overcoat layer on the opposite surface.

Thus, the transparent screen of the invention has been explained in detail; however, the invention is not intended to be limited to the examples described above. It is obvious that various improvements and modifications may be made to the extent that the gist of the invention is maintained.

### EXAMPLES

Features of the invention will be more specifically explained below by way of Examples. The materials, reagents, amounts of use, amounts of materials, ratios, treatments, procedures, and the like disclosed in the following Examples can be modified as appropriate as long as the gist of the invention is maintained. Therefore, the scope of the invention should not be interpreted limitedly by the specific examples described below.

### Example 1

(Production of Underlayer)

A composition as described below was stirred and dissolved in a vessel that had been kept warm at 25° C., and thus an underlayer solution was prepared.

Underlayer solution (parts by mass)

| | |
|---|---|
| Propylene glycol monomethyl ether acetate | 67.8 |
| Dipentaerythritol hexaacrylate (manufactured by Nippon | 5.0 |
| Kayaku Co., Ltd., trade name: KAYARAD DPHA) | |
| MEGAFAC RS-90 (manufactured by DIC Corporation) | 26.7 |
| IRGACURE 819 (manufactured by BASF SE) | 0.5 |

The underlayer solution prepared as described above was applied on a transparent PET (polyethylene terephthalate, manufactured by Toyobo Co., Ltd., COSMOSHINE A4100) substrate having a thickness of 100 μm using a bar coater at a coating amount of 3 mL/m². Subsequently, the substrate was heated so as to obtain a film surface temperature of 90° C., and the solution was dried for 120 seconds. Then, the underlayer solution was irradiated with ultraviolet radiation at a dose of 700 mJ/cm² using an ultraviolet irradiation apparatus in an atmosphere purged with nitrogen at an oxygen concentration of 100 ppm or less, and a crosslinking reaction was carried out. Thus, an underlayer was produced.

The haze value of the PET substrate was measured, and the haze value was 1%.

(Formation of Cholesteric Liquid Crystal Dots)

A composition as described below was stirred and dissolved in a vessel that had been kept warm at 25° C., and thus a cholesteric liquid crystal ink solution G (liquid crystal composition) was prepared.

Cholesteric liquid crystal ink solution G (parts by mass)

| | |
|---|---|
| Methoxyethyl acrylate | 145.0 |
| Mixture of rod-like liquid crystal compounds as described below | 100.0 |
| IRGACURE 819 (manufactured by BASF SE) | 10.0 |
| Chiral agent A having the following structure | 5.78 |
| Surfactant having the following structure | 0.08 |

### Rod-Like Liquid Crystal Compound

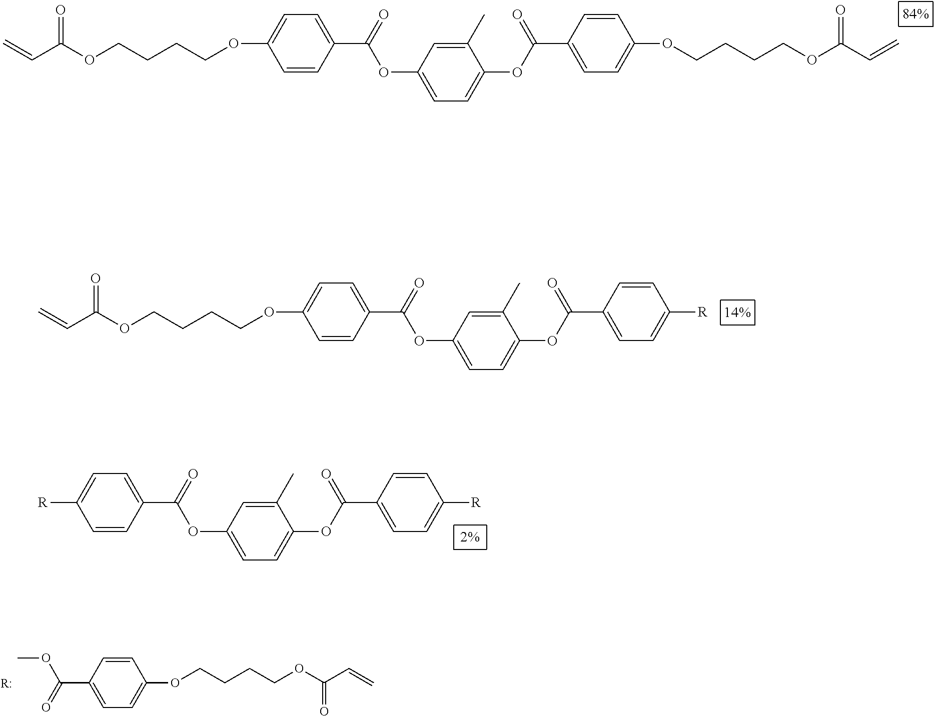

The numerical values are expressed in % by mass. R represents a group that is bonded to oxygen atom.

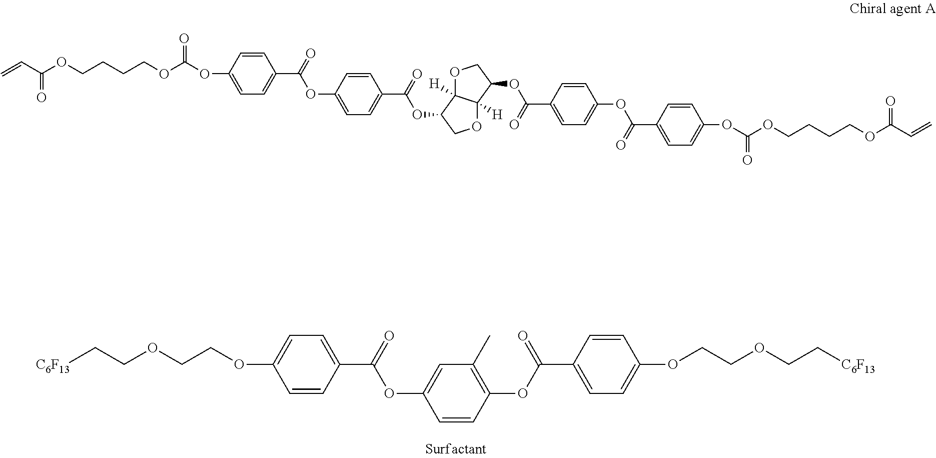

The cholesteric liquid crystal ink solution G is a material that forms green dots capable of reflecting light having a center wavelength of 550 nm.

The cholesteric liquid crystal ink solution G prepared as described above was applied as droplets on the underlayer on the PET produced as described above with an inkjet printer (DMP-2831, manufactured by Fujifilm Dimatix, Inc.) over the entire surface of a region having a size of 100 mm×100 mm at a distance between dot centers (pitch) in the vertical direction of 23 μm and a pitch in the horizontal direction of 46 μm, and the ink solution was dried for 30 seconds at 95° C. Subsequently, the ink solution was irradiated with ultraviolet radiation at a dose of 500 mJ/cm² at room temperature using an ultraviolet irradiation apparatus, and was thereby cured to form dots. Thus, a transparent screen was obtained.

(Evaluation of Dot Shape and Cholesteric Structure)

Ten dots were randomly selected from among the dots of the transparent screen obtained as described above, and the shape of the dots was observed with a laser microscope (manufactured by Keyence Corporation). The dots had an average diameter of 23 μm and an average maximum height of 10 μm, and the angle formed at a contacting portion of both the dot surface at the dot edge and the underlayer surface (contact angle) was 83 degrees on the average. The height increased continuously in a direction extending from the dot edge toward the center.

One dot positioned at the center of the transparent screen obtained as described above was cut perpendicularly to the PET substrate plane at a plane including the dot center, and the cross-section was observed with a scanning electron microscope. As a result, a striped pattern of bright parts and dark parts could be recognized inside the dot, and a cross-sectional view as illustrated in FIG. 8 was obtained (the site on the outer side of the hemispherical shape on the right-hand side of the cross-sectional view is a burr created at the time of cutting).

From the cross-sectional view, the angle formed by the direction of the normal line to a line that was formed by the first dark line as counted from the surface on the air interface side of the dot and the surface on the air interface side, was measured, and the angles at the dot edge, between the dot edge and the center, and at the dot center were 90 degrees, 89 degrees, and 90 degrees, respectively. The angle formed by the direction of the normal line to a line that was formed by a dark line and the direction of the normal line to the PET substrate, decreased continuously from 35 degrees, 18 degrees, to 0 degrees in the order of positions at the dot edge, between the dot edge and the center, and at the dot center, respectively.

(Dot Area Ratio)

Ten dots were randomly selected from among the dots of the transparent screen obtained as described above, and the shape of the dots was observed with a laser microscope (manufactured by Keyence Corporation). The area ratio was measured at 5 sites of regions having a size of 1 mm×1 mm, and the average value of the area ratio was 6.5%.

(Formation of Overcoat Layer)

A composition as described below was stirred and dissolved in a vessel that had been kept warm at 25° C., and thus a coating liquid for an overcoat layer was prepared.

Coating liquid for an overcoat layer 1 (parts by mass)

| | |
|---|---|
| Acetone | 100.0 |
| KAYARAD DPCA-30 (manufactured by Nippon Kayaku Co., | 30.0 |
| Ltd.) | |
| EA-200 (manufactured by Osaka Gas Chemicals Co., Ltd.) | 70.0 |
| IRGACURE 819 (registered trademark) (manufactured by BASF | 3.0 |
| SE) | |

The coating liquid for an overcoat layer 1 prepared as described above was applied on the underlayer on which cholesteric liquid crystal dots had been formed, using a bar coater at a coating amount of 40 mL/m². Subsequently, the substrate was heated so as to obtain a film surface temperature of 50° C., and the coating liquid was dried for 60 seconds. Then, the coating liquid was irradiated with ultraviolet radiation at a dose of 500 mJ/cm² using an ultraviolet irradiation apparatus, and a crosslinking reaction was carried out to produce an overcoat layer. Thus, a transparent screen as illustrated in FIG. 1A to FIG. 1C was obtained.

The refractive index of the dot was 1.58, the refractive index of the overcoat layer was 1.58, and the difference in the refractive index was 0.

### Example 2

A transparent screen as illustrated in FIG. 3A was produced in the same manner as in Example 1, except that the transparent screen was configured to arrange the plurality of the dot row units including three dots having sizes different from each other.

Specifically, the size of the largest dot is the same as that of the dot in Example 1, an average diameter thereof is 23 μm, and an average maximum height thereof is 10 μm. The intermediate dot has a shape similar to that of the largest dot and the diameter thereof is 0.8 times the largest dot. The smallest dot has a shape similar to that of the largest dot and the diameter thereof is 0.6 times the largest dot.

In the dot row unit, the largest dot, the intermediate dot, and the smallest dot are arranged in this order so as to gradually change the sizes of dots. Furthermore, the arrangement direction and the arrangement order of the dot in each dot row unit are made to coincide with each other.

In the arrangement direction of the dot in the dot row unit, the distance between the adjacent dot row units is 23 μm. In the direction orthogonal to the arrangement direction of the dot in the dot row unit, the distance between the adjacent dot row units is 23 μm in terms of the distance between the largest dots.

### Example 3

A transparent screen as illustrated in FIG. 4 was produced in the same manner as in Example 1, except that the transparent screen was configured to include three kinds of dots that reflect light in the wavelength regions different from each other and to form the dot row unit including three dots of the same kind.

Specifically, a transparent screen was produced by forming a plurality of dot row units including three dots formed by the cholesteric liquid crystal ink solution G, a plurality of dot row units including three dots formed by the cholesteric liquid crystal ink solution R, and a plurality of dot row units including three dots formed by the cholesteric liquid crystal ink solution B, using the cholesteric liquid crystal ink solution G, and a cholesteric liquid crystal ink solution R and a cholesteric liquid crystal ink solution B that will be described below, so as to be arranged as illustrated in FIG. 4.

The cholesteric liquid crystal ink solution R was prepared in the same manner as in the case of the cholesteric liquid crystal ink solution G, except that the amount of addition of the chiral agent A was changed to 4.66 parts by mass. Also, the cholesteric liquid crystal ink solution B was prepared in the same manner as in the case of the cholesteric liquid crystal ink solution G, except that the amount of addition of the chiral agent A was changed to 7.61 parts by mass.

The cholesteric liquid crystal ink solution R is a material for forming red dots that reflect light having a center wavelength of 650 nm, and the cholesteric liquid crystal ink solution B is a material for forming blue dots that reflect light having a center wavelength of 450 mm.

### Comparative Example 1

A transparent screen was produced by applying a coating liquid containing beads (XX-151S; perfectly spherical particles of a crosslinked polymethyl methacrylate-styrene copolymer, manufactured by Sekisui Chemical Co., Ltd.) having an average particle size of 10 μm in a mixed solvent of MIBK (methyl isobutyl ketone) and MEK (methyl ethyl ketone) as a reflective material, on a transparent PET (polyethylene terephthalate, manufactured by Toyobo Co., Ltd., COSMOSHINE A4100) substrate having a thickness of 100 μm.

<Evaluation>

For the transparent screens of Examples and Comparative Examples thus produced, transparency, front surface brightness, and the right and left brightness were evaluated.

(Evaluation of Transparency)

Regarding the evaluation of transparency, the haze value was measured using a haze meter NDH 4000 (manufactured by Nippon Denshoku Industries Co., Ltd.), and transparency was evaluated according to the following criteria.

A: Haze value is 10% or less.

B: Haze value is 10% or more and less than 15%.

C: Haze value is 15% or more and less than 20%.

D: Haze value is 20% or more and less than 25%.

E: Haze value is 25% or more.

(Evaluation of Front Surface Brightness and Right and Left Brightness 1)

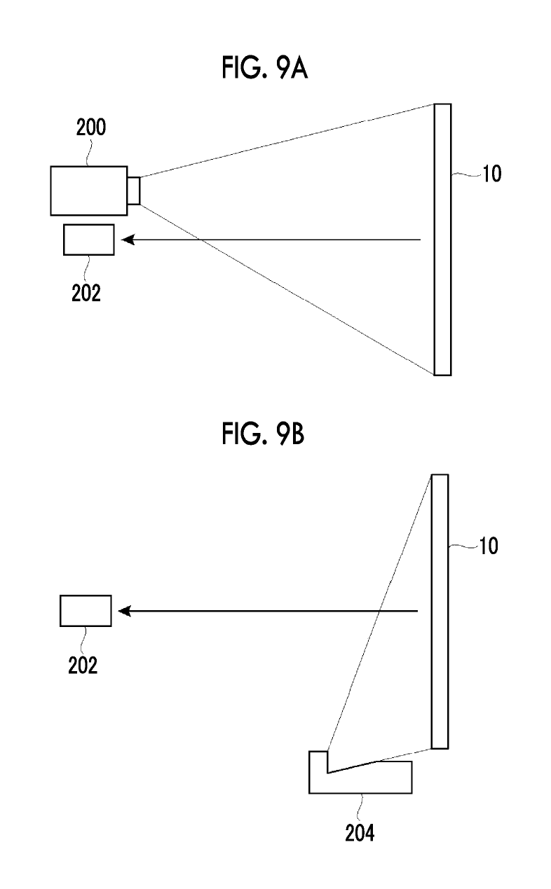

Regarding the evaluation of the front surface brightness and the right and left brightness, a transparent screen was placed in a conventional office environment, and as illustrated in FIG. 9A, a bright state was displayed with white light from an angle close to a front surface of the transparent screen using a standard focus projector 200 (NP-M362WJD manufactured by Nippon Electric Company, Limited), and brightness was measured with a brightness meter 202 (brightness colorimeter BM-5A manufactured by Topcon Technohouse Corporation).

An angle of video light from the standard focus projector projected to the center of the transparent screen (an angle of a line perpendicular to the principal surface of the transparent screen set to 0°) was 10°.

The front surface brightness was measured after the brightness meter was disposed at a position 3 m away in the normal line direction passing through the center of the transparent screen.

The right and left brightness was measured by using an average value of values measured after the brightness meter was disposed at a position 3 m away in a direction which was inclined by 60° to the right and left sides of the transparent screen.

The relative value of the brightness with respect to Comparative Example 1 was determined and was evaluated according to the following criteria.

A: Brightness is higher than 2.0.

B: Brightness is higher than 1.1 and 2.0 or lower.

C: Brightness is higher than 1.0 and 1.1 or lower.

D: Brightness is 1.0 or lower.

(Evaluation of Front Surface Brightness and Right and Left Brightness 2)

The front surface brightness and the right and left brightness were measured as described above using a short focus projector 204 illustrated in FIG. 9B.

As the short focus projector, NP-UM351WJL manufactured by Nippon Electric Company, Limited was used.

An angle of video light from the short focus projector projected to the center of the transparent screen was 55°.

The results are presented in Table 1.

In Table 1, under the item of the reflective material, a reflective material that used dots formed of a cholesteric liquid crystal material is indicated as “Ch”. An overcoat layer is indicated as an OC layer.

TABLE 1

| | | | | Comparative Example | Example | | |
|---|---|---|---|---|---|---|---|
| | | | | 1 | 1 | 2 | 3 |
| Configuration | Substrate | Type | | PET | PET | PET | PET |
| | Reflective | Type | | Beads | Ch | Ch | Ch |
| | material | Selective | 450 nm | — | — | — | 450 nm |
| | | reflection | 550 nm | — | 550 nm | 550 nm | 550 nm |
| | | wavelength | 650 nm | — | — | — | 650 nm |

| | | | | | |
|---|---|---|---|---|---|
| | Dot arrangement | — | Vertical direction | Size change | Three vertical |
| | | | | | directions |
| | Dot size | — | All same size | Three different | All same size |
| | | | | sizes | |
| OC layer | Present/Absent | Absent | Present | Present | Present |

| Evaluation | Transparency | | E | A | A | A |
|---|---|---|---|---|---|---|
| | Standard focus projector | Front surface | C | A | A | A |
| | | brightness | | | | |
| | | Right and left | C | A | B | A |
| | | brightness | | | | |
| | Short focus projector | Front surface | C | B | A | A |
| | | brightness | | | | |
| | | Right and left | C | B | A | A |
| | | brightness | | | | |

As shown in Table 1, it can be seen that Examples 1 to 3, which are transparent screens of the invention, can increase all of the transparency, the front surface brightness, and the right and left brightness compared to Comparative Example 1.

From a comparison between Example 1 and Example 2, it can be seen that by adopting a configuration in which the dot row unit is formed by arranging dots having different sizes in the order of sizes, the front surface brightness and the right and left brightness in a case of using the short focus projector can be further increased.

From a comparison between Example 1 and Example 3, it can be seen that by using two or more kinds of dots having selective reflection wavelengths different from each other, the front surface brightness and the right and left brightness can be further increased.

From the above-described results, the effects of the invention are obvious.

### EXPLANATION OF REFERENCES

10, 10a to 10e, 10i: transparent screen

12: substrate

14: support

16: overcoat layer

18: underlayer

20, 20c to 20e: dot

20R: red dot

20G: green dot

20B: blue dot

20T: three-layered dot

20W: two-layered dot

20S: six-layered dot

21R: red region

21G: green region

21B: blue region

21m: right-handed polarizing region

21h: left-handed polarizing region

21Rm: right-handed polarizing red region

21Rh: left-handed polarizing red region

21Gm: right-handed polarizing green region

21Gh: left-handed polarizing green region

21Bm: right-handed polarizing blue region

21Bh: left-handed polarizing blue region

22, 22a to 22e: dot row unit

What is claimed is:

1. A transparent screen comprising:
a substrate capable of transmitting light; and
a plurality of dots formed on a surface of the substrate, each of the dots having wavelength-selective reflectivity and being formed of a liquid crystal material having a cholesteric structure,
wherein the cholesteric structure gives a striped pattern of bright parts and dark parts in a cross-sectional view of the dot observed by a scanning electron microscope,
the dot includes a portion having a height that increases continuously to the maximum height in a direction extending from the edge toward the center of the dot,
in the portion, the angle formed by the normal line to a line that is formed by a first one of the dark parts as counted from the surface of the dot on the opposite side of the substrate and the surface of the dot is in the range of 70° to 90°, and
a plurality of dot row units in which two or more dots are adjacently arranged along one direction are formed.

2. The transparent screen according to claim 1, wherein in the plurality of dot row units, arrangement directions of the dots are parallel to each other.

3. The transparent screen according to claim 1, wherein a distance between dots adjacent to each other in a direction orthogonal to the arrangement direction of the dot in the dot row unit is longer than a distance between the dots in the dot row unit.

4. The transparent screen according to claim 2, wherein a distance between dots adjacent to each other in a direction orthogonal to the arrangement direction of the dot in the dot row unit is longer than a distance between the dots in the dot row unit.

5. The transparent screen according to claim 1, wherein in the dot row unit, diameters of the dots are identical.

6. The transparent screen according to claim 4, wherein in the dot row unit, diameters of the dots are identical.

7. The transparent screen according to claim 1, wherein in the dot row unit, the dots are formed so that the diameters of the dots are gradually reduced in one direction of the arrangement directions of the dots.

8. The transparent screen according to claim 4, wherein in the dot row unit, the dots are fanned so that the diameters of the dots are gradually reduced in one direction of the arrangement directions of the dots.

9. The transparent screen according to claim 1, wherein the plurality of dots include two or more kinds of dots that reflect light in wavelength regions different from each other.

10. The transparent screen according to claim 6, wherein the plurality of dots include two or more kinds of dots that reflect light in wavelength regions different from each other.

11. The transparent screen according to claim 8, wherein the plurality of dots include two or more kinds of dots that reflect light in wavelength regions different from each other.

12. The transparent screen according to claim 9, wherein in the dot row unit, the reflection wavelengths of the dots are identical.

13. The transparent screen according to claim 10, wherein in the dot row unit, the reflection wavelengths of the dots are identical.

14. The transparent screen according to claim 11, wherein in the dot row unit, the reflection wavelengths of the dots are identical.

15. The transparent screen according to claim 1, which includes dots each having, in a single dot, two or more regions that reflect light in wavelength regions different from each other.

16. The transparent screen according to claim 13, which includes dots each having, in a single dot, two or more regions that reflect light in wavelength regions different from each other.

17. The transparent screen according to claim 14, which includes dots each having, in a single dot, two or more regions that reflect light in wavelength regions different from each other.

18. The transparent screen according to claim 1, wherein the liquid crystal material is a material obtainable by curing a liquid crystal composition including a liquid crystal compound, a chiral agent, and a surfactant.

19. The transparent screen according to claim 16, wherein the liquid crystal material is a material obtainable by curing a liquid crystal composition including a liquid crystal compound, a chiral agent, and a surfactant.

20. The transparent screen according to claim 17, wherein the liquid crystal material is a material obtainable by curing a liquid crystal composition including a liquid crystal compound, a chiral agent, and a surfactant.
